(19) United States
(12) Patent Application Publication
(10) Pub. No.: US 2026/0333337 A1
(43) Pub. Date: Oct. 22, 2026

(54) EXCEPTIONAL RESOURCES FOR ENERGY HARVESTING DEVICES

(71) Applicant: QUALCOMM Incorporated, San Diego, CA (US)

(72) Inventors: Ahmed ELSHAFIE, San Diego, CA (US); Alexandros MANOLAKOS, Escondido, CA (US); Huilin XU, Temecula, CA (US); Linhai HE, San Diego, CA (US); Yuchul KIM, San Diego, CA (US)

(21) Appl. No.: 19/113,857

(22) PCT Filed: Oct. 23, 2023
(86) PCT No.: PCT/US2023/035733

§ 371 Date: Mar. 20, 2025

(30) Foreign Application Priority Data
Dec. 9, 2022 (GR) 20220101020

(51) Int. Cl. H04W 72/044; H04W 52/02; H04W 72/02; H04W 72/0453; H04W 72/20

(52) U.S. Cl. CPC H04W 72/0473; H04W 52/0277; H04W 72/02; H04W 72/0453; H04W 72/20

(57) ABSTRACT

Methods, systems, and devices for wireless communications are described. A first wireless device such as a user equipment (UE) may receive a control message that indicates a set of conditional energy resources available for use by the first wireless device to receive energy signaling from a second wireless device, or to transmit energy signaling to the second wire-less device. The UE may receive the energy signaling from the second wireless device or may transmit the energy signaling to the second wireless device based on one or more energy threshold conditions. In such cases, the UE may detect that the one or more energy threshold conditions have been satisfied, and may receive or transmit the energy signaling via the set of conditional energy resources based on satisfying the one or more energy threshold conditions at the UE or at the second wireless device.

### CROSS REFERENCE

The present Application is a 371 national stage filing of International PCT Application No. PCT/US2023/035733 by ELSHAFIE et al. entitled “EXCEPTIONAL RESOURCES FOR ENERGY HARVESTING DEVICES,” filed Oct. 23, 2023; and claims priority to Greece Patent Application No. 20220101020 by ELSHAFIE, et al., entitled “EXCEPTIONAL RESOURCES FOR ENERGY HARVESTING DEVICES,” filed Dec. 9, 2022 each of which is assigned to the assignee hereof, and each of which is expressly incorporated by reference in its entirety herein.

### TECHNICAL FIELD

The following relates generally to wireless communications, including exceptional resources for energy harvesting devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support exceptional resources for energy harvesting devices. For example, the described techniques provide for support for access to an “exceptional” resource pool or an “exceptional” band or sub-band (e.g., a conditional resource pool or condition band or sub-band) for wireless device to use for transmitting or receiving energy signaling when one or more threshold conditions are met. For example, a first wireless device may receive a control message that indicates a set of conditional energy resources available for use by the first wireless device to receive energy signaling from a second wireless device, or to transmit energy signaling to the second wireless device. Then, the first wireless device may receive the energy signaling from the second wireless device or may transmit the energy signaling to the second wireless device based on one or more energy threshold conditions being satisfied. Specifically, the first wireless device may be configured with a set of conditional resource pools or conditional bands or sub-bands, and may use the resources for receiving or transmitting energy signals to or from a second wireless device or a network device. In such examples, these resources may be used when the battery level of the first or second wireless device falls below a threshold, the charging rate of the first or second wireless device falls below a threshold, when the first or second wireless device would benefit from increased power to send high-priority data, among other conditions.

A method for wireless communications at a first wireless device is described. The method may include receiving a control message that indicates a set of conditional energy resources available for use by the first wireless device to receive energy signaling from a second wireless device based on one or more energy threshold conditions, detecting that the one or more energy threshold conditions have been satisfied at the first wireless device, and receiving the energy signaling via the set of conditional energy resources based on the one or more energy threshold conditions being satisfied at the first wireless device.

An apparatus for wireless communications at a first wireless device is described. The apparatus may include at least one processor, and memory coupled with the at least one processor, the memory storing instructions executable by the at least one processor (e.g., directly, indirectly, after pre-processing, or without pre-processing) to cause the first wireless device to receive a control message that indicates a set of conditional energy resources available for use by the first wireless device to receive energy signaling from a second wireless device based on one or more energy threshold conditions, detect that the one or more energy threshold conditions have been satisfied at the first wireless device, and receive the energy signaling via the set of conditional energy resources based on the one or more energy threshold conditions being satisfied at the first wireless device.

Another apparatus for wireless communications at a first wireless device is described. The apparatus may include means for receiving a control message that indicates a set of conditional energy resources available for use by the first wireless device to receive energy signaling from a second wireless device based on one or more energy threshold conditions, means for detecting that the one or more energy threshold conditions have been satisfied at the first wireless device, and means for receiving the energy signaling via the set of conditional energy resources based on the one or more energy threshold conditions being satisfied at the first wireless device.

A non-transitory computer-readable medium storing code for wireless communications at a first wireless device is described. The code may include instructions executable by at least one processor to receive a control message that indicates a set of conditional energy resources available for use by the first wireless device to receive energy signaling from a second wireless device based on one or more energy threshold conditions, detect that the one or more energy threshold conditions have been satisfied at the first wireless device, and receive the energy signaling via the set of conditional energy resources based on the one or more energy threshold conditions being satisfied at the first wireless device.

In some examples of the method, apparatuses, and non-transitory computer-readable medium described herein, the set of conditional energy resources includes a set of one or more resource pools available for use by the first wireless device and the method, apparatuses, and non-transitory computer-readable medium may include further operations, features, means, or instructions for receiving, from the second wireless device, the energy signaling via the set of one or more resource pools, where a selection of the set of one or more resource pools may be based on the one or more energy threshold conditions being satisfied.

In some examples of the method, apparatuses, and non-transitory computer-readable medium described herein, the set of conditional energy resources includes a set of one or more sub-bands available for use by the first wireless device and the method, apparatuses, and non-transitory computer-readable medium may include further operations, features, means, or instructions for receiving, from the second wireless device, the energy signaling via the set of one or more sub-bands, where a selection of the set of one or more sub-bands may be based on the one or more energy threshold conditions being satisfied.

In some examples of the method, apparatuses, and non-transitory computer-readable medium described herein, the one or more energy threshold conditions include an energy threshold associated with a communication link between the first wireless device and a network entity and the method, apparatuses, and non-transitory computer-readable medium may include further operations, features, means, or instructions for receiving the energy signaling via the set of conditional energy resources based on one or more of: an energy level associated with the communication link being lower than the energy threshold, a radio link failure on the communication link, or both.

In some examples of the method, apparatuses, and non-transitory computer-readable medium described herein, the one or more energy threshold conditions include a battery level threshold at the first wireless device and the method, apparatuses, and non-transitory computer-readable medium may include further operations, features, means, or instructions for receiving the energy signaling via the set of conditional energy resources based on a battery level of the first wireless device being lower than the battery level threshold.

In some examples of the method, apparatuses, and non-transitory computer-readable medium described herein, the one or more energy threshold conditions include a charging rate threshold at the first wireless device and the method, apparatuses, and non-transitory computer-readable medium may include further operations, features, means, or instructions for receiving the energy signaling via the set of conditional energy resources based on a charging rate of the first wireless device being lower than the charging rate threshold.

In some examples of the method, apparatuses, and non-transitory computer-readable medium described herein, the one or more energy threshold conditions include a threshold quantity of energy providing wireless devices associated with a second set of energy resources and the method, apparatuses, and non-transitory computer-readable medium may include further operations, features, means, or instructions for receiving the energy signaling via the set of conditional energy resources based on a quantity of energy providing wireless devices associated with the second set of energy resources being below the threshold quantity of energy providing wireless devices.

In some examples of the method, apparatuses, and non-transitory computer-readable medium described herein, the one or more energy threshold conditions include a threshold quantity of energy providing wireless devices associated with the set of conditional energy resources and the method, apparatuses, and non-transitory computer-readable medium may include further operations, features, means, or instructions for receiving the energy signaling via the set of conditional energy resources based on a quantity of energy providing wireless devices associated with the set of conditional energy resources exceeding the threshold quantity of energy providing wireless devices.

In some examples of the method, apparatuses, and non-transitory computer-readable medium described herein, the one or more energy threshold conditions include a threshold corresponding to a reduction in energy of the first wireless device over a time duration and the method, apparatuses, and non-transitory computer-readable medium may include further operations, features, means, or instructions for receiving the energy signaling via the set of conditional energy resources based on the reduction in the energy of the first wireless device over the time duration exceeding the threshold.

In some examples of the method, apparatuses, and non-transitory computer-readable medium described herein, the one or more energy threshold conditions include a threshold decrease in a predicted energy state of the first wireless device over a time duration and the method, apparatuses, and non-transitory computer-readable medium may include further operations, features, means, or instructions for receiving the energy signaling via the set of conditional energy resources based on the predicted energy state of the first wireless device decreasing an amount greater than the threshold decrease.

In some examples of the method, apparatuses, and non-transitory computer-readable medium described herein, the one or more energy threshold conditions include a threshold charging rate of the first wireless device over a time duration and the method, apparatuses, and non-transitory computer-readable medium may include further operations, features, means, or instructions for estimating a future charging rate of the first wireless device based on a current charging rate of the first wireless device and receiving the energy signaling via the set of conditional energy resources based on the estimated future charging rate of the first wireless device being less than the threshold charging rate.

In some examples of the method, apparatuses, and non-transitory computer-readable medium described herein, the one or more energy threshold conditions include a threshold power consumption rate of the first wireless device over a time duration and the method, apparatuses, and non-transitory computer-readable medium may include further operations, features, means, or instructions for estimating a future power consumption rate of the first wireless device based on a current power consumption rate of the first wireless device and receiving the energy signaling via the set of conditional energy resources based on the estimated future power consumption rate of the first wireless device being less than the threshold power consumption rate.

Some examples of the method, apparatuses, and non-transitory computer-readable medium described herein may further include operations, features, means, or instructions for receiving an indication of a ranking for one or more conditional energy resources of the set of conditional energy resources available for use by the first wireless device and receiving the energy signaling via at least one conditional energy resource of the one or more conditional energy resources based on the ranking, where the ranking indicates an availability of the one or more conditional energy resources.

In some examples of the method, apparatuses, and non-transitory computer-readable medium described herein, the one or more energy threshold conditions include a battery level threshold of the first wireless device and the method, apparatuses, and non-transitory computer-readable medium may include further operations, features, means, or instructions for receiving a message requesting transmission of one or more high priority data messages from the first wireless device to the second wireless device, receiving the energy signaling via the set of conditional energy resources based on a battery level of the first wireless device being lower than the battery level threshold, a charging rate of the first wireless device being lower than the charging rate threshold, a power consumption of the first wireless device being greater than the power consumption threshold, or any combination thereof, and transmitting the one or more high priority data messages to the second wireless device based on the received energy signaling.

Some examples of the method, apparatuses, and non-transitory computer-readable medium described herein may further include operations, features, means, or instructions for receiving an instruction message that instructs the first wireless device to use the set of conditional energy resources.

Some examples of the method, apparatuses, and non-transitory computer-readable medium described herein may further include operations, features, means, or instructions for receiving the energy signaling via a first resource of the set of conditional energy resources based on a first threshold of the one or more energy threshold conditions being satisfied and receiving the energy signaling via a second resource of the set of conditional energy resources based on a second threshold of the one or more energy threshold conditions being satisfied.

In some examples of the method, apparatuses, and non-transitory computer-readable medium described herein, the control message includes a master information block (MIB), a system information block (SIB), a radio resource control (RRC) message, an assistance information message, a layer indication message, or any combination thereof.

In some examples of the method, apparatuses, and non-transitory computer-readable medium described herein, the control message includes a unicast configuration message, a broadcast configuration message, a multicast configuration message, or any combination thereof.

In some examples of the method, apparatuses, and non-transitory computer-readable medium described herein, the set of conditional energy resources available for use by the first wireless device to receive the energy signaling from the second wireless device may be different from a second set of one or more resources available for use by the first wireless device to receive data messaging, control messaging, or both, from the second wireless device.

A method for wireless communications at a first wireless device is described. The method may include receiving a control message that indicates a set of conditional energy resources available for use by the first wireless device to transmit energy signaling to a second wireless device based on one or more energy threshold conditions, detecting that the one or more energy threshold conditions have been satisfied at the first wireless device, at the second device, or both, and transmitting the energy signaling via the set of conditional energy resources based on the one or more energy threshold conditions being satisfied at the first wireless device, the second wireless device, or both.

An apparatus for wireless communications at a first wireless device is described. The apparatus may include at least one processor, and memory coupled with the at least one processor, the memory storing instructions executable by the at least one processor to cause the first wireless device to receive a control message that indicates a set of conditional energy resources available for use by the first wireless device to transmit energy signaling to a second wireless device based on one or more energy threshold conditions, detect that the one or more energy threshold conditions have been satisfied at the first wireless device, at the second device, or both, and transmit the energy signaling via the set of conditional energy resources based on the one or more energy threshold conditions being satisfied at the first wireless device, the second wireless device, or both.

Another apparatus for wireless communications at a first wireless device is described. The apparatus may include means for receiving a control message that indicates a set of conditional energy resources available for use by the first wireless device to transmit energy signaling to a second wireless device based on one or more energy threshold conditions, means for detecting that the one or more energy threshold conditions have been satisfied at the first wireless device, at the second device, or both, and means for transmitting the energy signaling via the set of conditional energy resources based on the one or more energy threshold conditions being satisfied at the first wireless device, the second wireless device, or both.

A non-transitory computer-readable medium storing code for wireless communications at a first wireless device is described. The code may include instructions executable by at least one processor to receive a control message that indicates a set of conditional energy resources available for use by the first wireless device to transmit energy signaling to a second wireless device based on one or more energy threshold conditions, detect that the one or more energy threshold conditions have been satisfied at the first wireless device, at the second device, or both, and transmit the energy signaling via the set of conditional energy resources based on the one or more energy threshold conditions being satisfied at the first wireless device, the second wireless device, or both.

In some examples of the method, apparatuses, and non-transitory computer-readable medium described herein, the set of conditional energy resources includes a set of one or more sub-bands available for use by the first wireless device and the method, apparatuses, and non-transitory computer-readable medium may include further operations, features, means, or instructions for transmitting, to the second wireless device, the energy signaling via the set of one or more sub-bands, the one or more resource pools, or both, based on the one or more energy threshold conditions being satisfied.

In some examples of the method, apparatuses, and non-transitory computer-readable medium described herein, the one or more energy threshold conditions include an energy threshold associated with a communication link between the second wireless device and a network entity and the method, apparatuses, and non-transitory computer-readable medium may include further operations, features, means, or instructions for transmitting the energy signaling via the set of conditional energy resources based on one or more of: an energy level associated with the communication link being lower than the energy threshold, a radio link failure on the communication link, or both.

In some examples of the method, apparatuses, and non-transitory computer-readable medium described herein, the one or more energy threshold conditions include a battery level threshold at the second wireless device and the method, apparatuses, and non-transitory computer-readable medium may include further operations, features, means, or instructions for receiving an indication that a battery level of the second wireless device may be lower than the battery level threshold, a charging rate of the second wireless device may be lower than the charging rate threshold, or both and transmitting the energy signaling via the set of conditional energy resources based on the indication that the battery level of the second wireless device may be lower than the battery level threshold, the charging rate of the second wireless device may be lower than the charging rate threshold, or both.

In some examples of the method, apparatuses, and non-transitory computer-readable medium described herein, the one or more energy threshold conditions include a threshold quantity of energy providing wireless devices associated with a second set of energy resources and the method, apparatuses, and non-transitory computer-readable medium may include further operations, features, means, or instructions for transmitting the energy signaling via the set of conditional energy resources based on a quantity of energy providing wireless devices associated with the second set of energy resources being below the threshold quantity of energy providing wireless devices.

In some examples of the method, apparatuses, and non-transitory computer-readable medium described herein, the one or more energy threshold conditions include a threshold quantity of energy providing wireless devices associated with the set of conditional energy resources and the method, apparatuses, and non-transitory computer-readable medium may include further operations, features, means, or instructions for transmitting the energy signaling via the set of conditional energy resources based on a quantity of energy providing wireless devices associated with the set of conditional energy resources exceeding the threshold quantity of energy providing wireless devices.

In some examples of the method, apparatuses, and non-transitory computer-readable medium described herein, the one or more energy threshold conditions include a threshold corresponding to a reduction in energy of the second wireless device over a time duration and the method, apparatuses, and non-transitory computer-readable medium may include further operations, features, means, or instructions for receiving an indication that the reduction in energy of the second wireless device over the time duration exceeds the threshold and transmitting the energy signaling via the set of conditional energy resources based on the reduction in the energy of the second wireless device over the time duration exceeding the threshold.

In some examples of the method, apparatuses, and non-transitory computer-readable medium described herein, the one or more energy threshold conditions include a battery level threshold of the second wireless device and the method, apparatuses, and non-transitory computer-readable medium may include further operations, features, means, or instructions for receiving a message indicating that the second wireless device may have one or more high priority data messages to transmit and transmitting the energy signaling via the set of conditional energy resources based on a battery level of the second wireless device being lower than the battery level threshold, a charging rate of the second wireless device being lower than the charging rate threshold, a power consumption of the first wireless device being greater than the power consumption threshold, or any combination thereof.

Some examples of the method, apparatuses, and non-transitory computer-readable medium described herein may further include operations, features, means, or instructions for transmitting the energy signaling via a first resource of the set of conditional energy resources based on a first threshold of the one or more energy threshold conditions being satisfied and transmitting the energy signaling via a second resource of the set of conditional energy resources based on the one or more energy threshold conditions being satisfied.

A method for wireless communications at a network entity is described. The method may include configuring a set of conditional energy resources available for transmission of energy signaling to one or more wireless devices, reception of energy signaling between the one or more wireless devices, or both, based on one or more energy threshold conditions being satisfied, detecting that the one or more energy threshold conditions have been satisfied at the one or more wireless devices, and transmitting a control message to the one or more wireless devices that indicates the set of conditional energy resources.

An apparatus for wireless communications at a network entity is described. The apparatus may include at least one processor, and memory coupled with the at least one processor, the memory storing instructions executable by the at least one processor to cause the network entity to configure a set of conditional energy resources available for transmission of energy signaling to one or more wireless devices, reception of energy signaling between the one or more wireless devices, or both, based on one or more energy threshold conditions being satisfied, detect that the one or more energy threshold conditions have been satisfied at the one or more wireless devices, and transmit a control message to the one or more wireless devices that indicates the set of conditional energy resources.

Another apparatus for wireless communications at a network entity is described. The apparatus may include means for configuring a set of conditional energy resources available for transmission of energy signaling to one or more wireless devices, reception of energy signaling between the one or more wireless devices, or both, based on one or more energy threshold conditions being satisfied, means for detecting that the one or more energy threshold conditions have been satisfied at the one or more wireless devices, and means for transmitting a control message to the one or more wireless devices that indicates the set of conditional energy resources.

A non-transitory computer-readable medium storing code for wireless communications at a network entity is described. The code may include instructions executable by at least one processor to configure a set of conditional energy resources available for transmission of energy signaling to one or more wireless devices, reception of energy signaling between the one or more wireless devices, or both, based on one or more energy threshold conditions being satisfied, detect that the one or more energy threshold conditions have been satisfied at the one or more wireless devices, and transmit a control message to the one or more wireless devices that indicates the set of conditional energy resources.

### BRIEF DESCRIPTION OF THE DRAWINGS

FIGS. 1 and 2 illustrate examples of wireless communications systems that support exceptional resources for energy harvesting devices in accordance with one or more aspects of the present disclosure.

FIGS. 3 and 4 illustrates examples of process flows that support exceptional resources for energy harvesting devices in accordance with one or more aspects of the present disclosure.

FIGS. 5 and 6 show block diagrams of devices that support exceptional resources for energy harvesting devices in accordance with one or more aspects of the present disclosure.

FIG. 7 shows a block diagram of a communications manager that supports exceptional resources for energy harvesting devices in accordance with one or more aspects of the present disclosure.

FIG. 8 shows a diagram of a system including a device that supports exceptional resources for energy harvesting devices in accordance with one or more aspects of the present disclosure.

FIGS. 9 and 10 show block diagrams of devices that support exceptional resources for energy harvesting devices in accordance with one or more aspects of the present disclosure.

FIG. 11 shows a block diagram of a communications manager that supports exceptional resources for energy harvesting devices in accordance with one or more aspects of the present disclosure.

FIG. 12 shows a diagram of a system including a device that supports exceptional resources for energy harvesting devices in accordance with one or more aspects of the present disclosure.

FIGS. 13 through 17 show flowcharts illustrating methods that support exceptional resources for energy harvesting devices in accordance with one or more aspects of the present disclosure.

### DETAILED DESCRIPTION

In some wireless communications systems, wireless communications devices such as user equipment (UE) may communicate using sidelink communication techniques. For example, a UE may support mode 1 sidelink communications (e.g., in which a network entity assigns sidelink resources for the UE to use) or mode 2 sidelink communications (e.g., in which the UE autonomously selects sidelink resources to use). In some cases, however, the network entity may configure sidelink UEs with an additional set or pool of conditional resources, sometimes referred to as “exceptional resources,” that sidelink UEs may utilize when some threshold or exceptional conditions are met. For example, this conditional resource pool may be configured by a network entity for one or more UEs to use when a UE detects signaling degradation at the physical layer, or during radio link failure. In such cases, the network entity may configure the conditional resource pool so that UE may have access to additional resources to maintain continuous service during exceptional situations (e.g., during emergencies or other critical situations). In some such conditional situations, however, a UE may also benefit from access to energy harvesting resources (e.g., if a UE battery level drops below a threshold) so that the UE may receive or transmit energy signaling to improve service reliability and battery life.

Aspects of the present disclosure may support techniques for accessing a conditional resource pool or a conditional band or sub-band (e.g., an exceptional resource pool or band or sub-band) for UEs to use for transmitting or receiving energy signaling when one or more threshold conditions are met. Specifically, a UE may be configured with a set of conditional resource pools (for use in sidelink communications) or conditional bands or sub-bands (for use in direct communications with the network via a Uu link between the network and the UE). In some examples, the UE may be configured with these conditional bands, sub-bands, or resource pools via information sent from the network via a master information block (MIB), a system information block (SIB), a control message such as a radio resource control (RRC) configuration messaging, assistance information, or other configuration signaling. Once configured with the conditional resources, the UE may use the resources for receiving or transmitting energy signals to or from other UEs or network entities. For example, these resources may be used when a battery level of the falls below a threshold, a charging rate of the UE falls below a threshold, or when a UE would benefit from additional power to send high-priority data, among other conditions.

Aspects of the disclosure are initially described in the context of wireless communications systems. Aspects of the disclosure are further illustrated by and described with reference to process flows, apparatus diagrams, system diagrams, and flowcharts that relate to exceptional resources for energy harvesting devices.

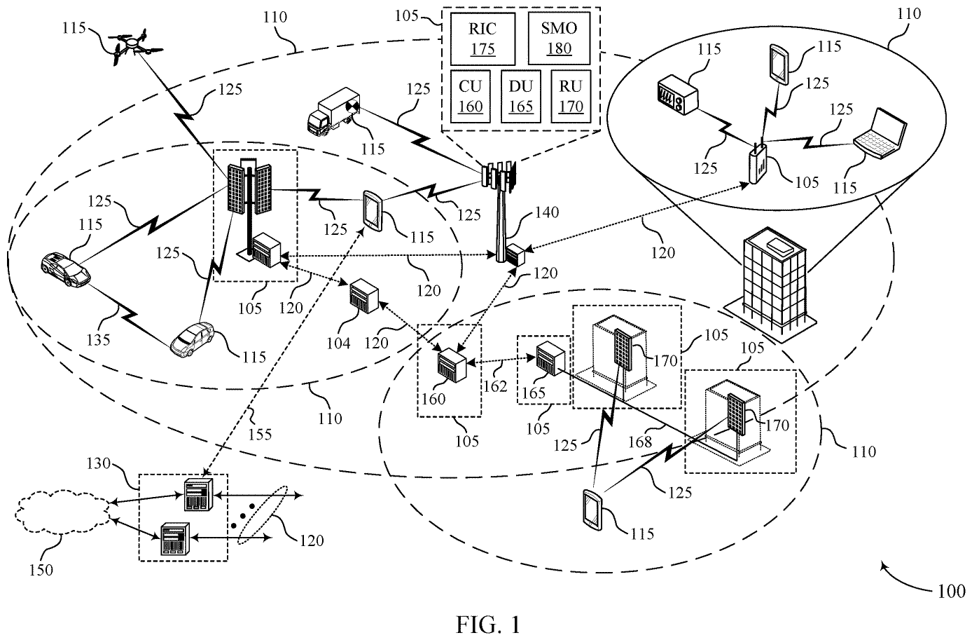

FIG. 1 illustrates an example of a wireless communications system 100 that supports exceptional resources for energy harvesting devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a Virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support exceptional resources for energy harvesting devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the one or more communication links 125. For example, a carrier used for one or more communication links 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, sidelink communications may utilize one or more sidelink configurations or sidelink pre-configurations (for example, using a parameter SL-FreqConfig) signaled via a system information block or other control signaling. In some examples, the sidelink configuration may include a point A parameter, a sidelink BWP configuration parameter (SL-BWP-config), a sidelink broadcast channel configuration (PSBCH-config), a subcarrier spacing parameter (scs-specificcarrier-list), or any combination thereof. In some examples, the sidelink BWP configuration parameter may include a generic BWP configuration including a bandwidth, location, subcarrier spacing, cyclic prefix, and time domain resource information. In some examples, the sidelink BWP configuration parameter may include one or more sidelink resource pool configurations such as transmission resource pools for mode 1 sidelink communications, transmission resource pools for mode 2 sidelink communications, receiving resource pools, or any combination thereof. In some examples, each resource pool configuration may include a configuration for PSSCH, PSCCH, and PSFCH, a number of subchannels, subchannel size, and a starting resource block, a channel busy ratio, modulation coding scheme, sensing configuration, and power control parameter. In such examples, one BWP may contain multiple receiving and transmitting resource pools, and physical layer channels may be configured per resource pool. In some other examples, the subcarrier spacing parameter may further include a configuration for bandwidth location that is associated with an indicated subcarrier spacing.

Wireless communications system 100 may support different modes of sidelink communications between UEs 115, for example, mode 1 sidelink and mode 2 sidelink. In some examples, a UE 115 may support mode 1 or mode 2 if it is in-coverage of a network entity 105, and may support mode 2 if it is out-of-coverage of the network entity 105. In mode 1 sidelink communications, the network entity 105 may schedule or assign sidelink resources for sidelink transmission, where both dynamic allocation via DCI format 3-x and configured transmissions (both Type-1 and Type-2) may be supported. In mode 2 sidelink communications, a UE 115 may autonomously select sidelink resources from a configured or preconfigured set of one or more sidelink resource pools based on various factors such as a channel sensing mechanism. For example, the UE 115 may identify the set of one or more sidelink resources using a channel sensing procedure. Then, based on the outcome of sensing (for example, based on a priority of different transmissions and a reference signal receive power (RSRP) of different transmissions), the UE 115 may select sidelink resources to use for sidelink transmissions.

In some examples of the wireless communications system 100, UEs 115 may communicate using sidelink communications. For example, the UEs 115 may support mode 1 sidelink communications (e.g., where a network entity 105 assigns resources for sidelink UEs 115 to use), or mode 2 sidelink communications (e.g., where sidelink UEs 115 autonomously select resources to use). In some cases, however, the network entity 105 may configure sidelink UEs 115 with a conditional resource pool, also referred to as a set of exceptional resources, that sidelink UEs 115 may utilize or otherwise access when some conditions are met. For example, this conditional resource pool may be configured for a UE 115 during some times and may be used in cases such as when a UE 115 detects physical layer problems on the link between the UE 115 and the network entity 105 (e.g., the Uu link), a link between the UE 115 and another sidelink UE, or during various scenarios such as radio link failure. This conditional resource pool may support availability of additional resources such that the UEs may maintain continuous service during exceptional situations (e.g., during emergencies or other critical situations). In some such conditional situations, however, a UE 115 may also benefit from access to energy harvesting resources (e.g., if a battery level of UE 115 drops below a threshold) to improve service reliability and battery life.

To support access to energy resources during such exceptional situations, Aspects of the present disclosure may describe techniques introducing a conditional resource pool or a conditional frequency band or sub-band (e.g., a conditional resource pool or conditional band or sub-band that is available during one or more situations) for UEs 115 to use for energy harvesting when some conditions are met or when one or more thresholds are satisfied. Specifically, a UE 115 may be configured with a set of conditional resource pools for use in sidelink communications with another UE 115. Additionally or alternatively, the UE 115 may be configured with one or more conditional bands or sub-bands for use on the Uu link between the network entity 105 and the UE 115. In some examples, the UE 115 may be configured with these conditional bands, sub-bands, or resource pools via information sent from the network via a control message, assistance information, or other configuration signaling. Once configured with the conditional resources, the UE 115 may use the resources for receiving or transmitting energy signals to or from other UEs 115 or network entities. For example, these resources may be used when the UEs 115 battery level falls below a threshold, when the UEs 115 charging rate falls below a threshold, when a UE 115 needs sufficient power to send high-priority data, among other conditions.

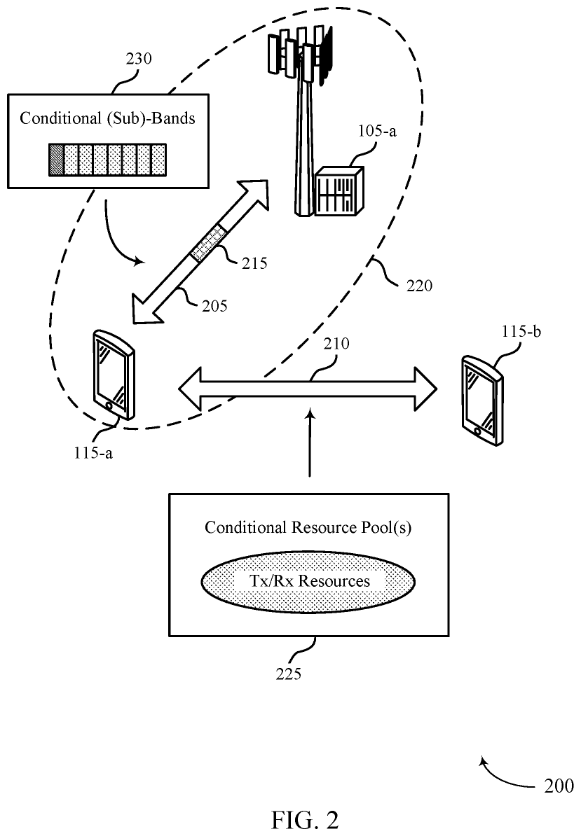

FIG. 2 illustrates an example of a wireless communications system 200 that supports exceptional resources for energy harvesting devices in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a network entity 105-a, each of which may be examples of corresponding devices described herein. The UE 115-a may communicate with the network entity 105-a via a communication link 205 (e.g., a Uu link) and the UE 115-a may communicate with the UE 115-b on a sidelink communication link 210 (e.g., a PC5 communication link), which may be an example of the one or more communication links 125 as described in FIG. 1. In this example, the UE 115-a and UE 115-b may support sidelink communications.

In some examples of the wireless communications system 200, the UEs 115 may be configured with either mode 1 sidelink communications (e.g., where the network entity 105-a assigns resources for the sidelink UEs 115 to use) or mode 2 sidelink communications (e.g., where the sidelink UEs 115 autonomously select resources to use). In some cases, for mode 1 sidelink communications, the network entity 105-a may support assigning both resources for the sidelink communications via a dynamic allocation via a control message 215 (e.g., a DCI message) and configured transmissions. In some other cases, when configured with mode 2 sidelink communications, the UEs 115 may autonomously select sidelink resources from a preconfigured sidelink resource pool based on channel sensing procedures. For example, the UE 115-a may identify a configured or preconfigured sidelink resource pool based on the outcome of the channel sensing procedure (e.g., based on signal priority and various RSRP measurements), the UE 115-a may select resources from the preconfigured sidelink resource pool for a transmission to the UE 115-b. In some cases, a UE 115-a may be in a coverage area 220 with the network entity 105-a, and may support both mode 1 and mode 2 sidelink communications. In some examples, the UE 115-b may be outside of the coverage area 220, and may support mode 2 sidelink communications. As such, the UE 115-a may be a synchronization reference UE (e.g., syncRef) for the sidelink communications with the UE 115-b, such that the UE 115-a may receive transmissions (e.g., synchronization information) or control messages (e.g., such as a control message 215) from the network entity 105-a which the UE 115-a may share with the UE 115-b via the sidelink communication link 210.

In some examples, the network entity 105-a may configure via the control message 215 (e.g., a system information bit (SIB) or RRC message) an “exceptional” or conditional resource pool 225 for the UEs 115 to use in “exceptional” or conditional situations. For example, when the UE 115-a detects physical layer problems on the communication link 205, for example, during radio link failure, or during other exceptional situations, the UE 115-a may use the conditional resource pool 225 to maintain continuous service (e.g., during emergencies or other critical situations). In some examples, the UEs 115 may use the conditional resource pool 225 before the UE 115 (e.g., the UE 115-a or the UE 115-b) performs an initiated connection establishment or reestablishment (e.g., such as a connection establishment between the network entity 105-a and the UE 115-a). In some other examples, the UEs 115 may use the conditional resource pool 225 during a handover procedure. For example, in some cases a UE 115 may not be configured with mode 1 sidelink communications, such as the UE 115-b. As such, during the handover procedure, the UE 115-b may use the conditional resource pool 225 if sensing results for a transmission resource pool are not available (e.g., the resource pool used for regular transmissions outside of the conditional situations). In some other examples, a UE 115 may be in an RRC idle or RRC inactive mode and the UE 115 may use the conditional resource pool 225 during cell reselection operations, before receiving sensing results for a target cell. In some cases, when initiating a transition from an RRC inactive to RRC connected mode and the transmission resource pool is not yet configured, the UE 115 may use the conditional resource pool 225 to maintain continuous service. In some other cases, the network entity 105-a may reconfigure the transmission resource pool for the UEs 115 via the control message 215, as such the UEs 115 may not have access to a transmission resource pool. In such cases, the UEs 115 may use the conditional resource pool 225 while monitoring for the control message 215 indicating a reconfiguration of the transmission resource pool.

In some examples, a UE 115 (e.g., such as the UE 115-a or the UE 115-b) may use the conditional resource pool 225 in cases where the UE 115 does not have a stable or reliable configuration of the transmission resource pool and if the UE 115 are non-removable from the wireless communications system 200 (e.g., the UE 115 is critical to the wireless communications system 200). In some such examples, the UEs 115 may use the conditional resource pool 225 by randomly selecting resources from the conditional resource pool 225 (e.g., via a serving cell configuration of a SIB21 or in dedicated signaling) to use temporarily. In some cases, the UE 115-a may transition to using the conditional resource pool 225 without any indication being transmitted to the UE 115-b, and the UEs 115 may continuously monitor the conditional resource pool 225 for physical sidelink control channel (PSCCH) transmissions. This use of the conditional resource pool 225 may support improved service continuity, for example, for public safety UEs 115 or other high importance UEs 115 which rely on service continuity. In some other examples, the UEs 115 may have a conditional situation that requires access to energy harvesting resources. For example, the UE 115-a may fall below a battery level threshold and may benefit from access to energy harvesting resources to improve service reliability and battery life.

To support such increased service and power reliability, UEs 115 may support use of the conditional resource pool 225 or a conditional (sub)-band 230 for energy harvesting (e.g., energy signaling) between wireless devices when one or more conditions are met. The conditional (sub)-band 230 may be configured for the communication link 205 between the network entity 105-a and the UE 115-a. In some examples, the network entity 105-a may configure the UEs 115 with the conditional resource pool 225 and the condition (sub)-band 230 via the control message 215. In some cases, the control message 215 may configure the UEs 115 via a MIB, SIB1, various random access messages (e.g., msg2, msg4, or both), or a different SIB, RRC configuration, using unicast assistance information, layer 1 (L1) indications, layer 2 (L2) indications, layer 3 (L3) indications, broadcast or groupcast (e.g., multicast) signaling. In such examples, the control message may include an assistance message or an indication of one or more bands, sub-bands, or resource pools that may be available for the UEs 115.

Additionally or alternatively, the techniques described herein may allow for the conditional resource pool 225 to be used for both transmission resources (e.g., transmitting energy signaling) and reception resources (e.g., receiving energy signaling). In some examples, there may be a conditional resource pool 225 for transmission of data, reception of data, transmission of energy signaling, reception of energy signaling, or a combination thereof. Further, the conditional resource pool 225 for energy reception and for energy transmission may be different that the conditional resource pool 225 used for sidelink communications between the UE 115-a and the UE 115-b.

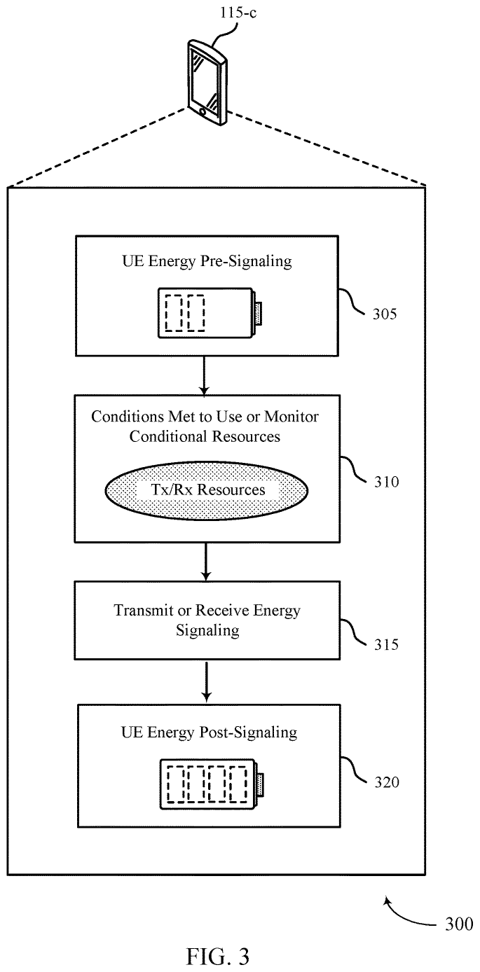

The UE 115-a and the UE 115-b, when configured by the network entity 105-a, may use the conditional resource pool 225 or the conditional (sub)-band 230 to improve service reliability and battery life of the UEs 115 in some “exceptional” or conditional situations. Example situations or conditions of when the conditional resource pool 225 or the conditional (sub)-band 230 may be used by the UEs 115, for energy harvesting, are further described herein, including with reference to FIG. 3.

FIG. 3 illustrates an example of a process flow 300 that supports exceptional resources for energy harvesting devices in accordance with one or more aspects of the present disclosure. For example, the process flow 300 may include a UE 115-c and a network entity 105, which may be examples of corresponding devices described herein. For example, the UE 115-c may communicate with a network entity on a Uu link and may communicate with another UE 115 on a sidelink communication link (e.g., a PC5 communication link) which may be an example of communication links described with reference to FIGS. 1 and 2.

In some examples, the UE 115-c may be an example of an energy harvesting UE 115 (e.g., a UE that receives energy signaling from one or more other wireless devices) or a power providing UE 115 (e.g., a UE that transmits or provides energy signaling to one or more other wireless devices). In some examples, the UE 115-c may be configured with a conditional resource pool and a conditional (sub)-band described with reference to FIG. 2. In some examples, the conditional resource pool and the conditional (sub)-band may be an example of the conditional resource pool 225 and the condition (sub)-band 230 described with reference to FIG. 2.

The process flow 300 may illustrate various conditions in which the UE 115-c may receive energy from the power providing UE 115, transmit energy to the energy harvesting UE 115, transmit signaling (e.g., to indicate to the power providing UE 115 or the network entity 105) to power providing UEs 115 to request help with energy or power issues, to indicate that the UE 115-c may use the conditional resource pool (and which resources) based on a condition being met, or any combination thereof. These conditions may be “extraordinary” or conditional situations in which the UE 115-c may be unable to use a different configured resource pool for transmitting or receiving energy signaling (e.g., the resource pool used for energy transfers in non-conditional situations), and may instead require access to the conditional resources (e.g., the conditional resource pool or the conditional (sub)-band) to support improved service reliability and battery life of the UE 115-c.

In some cases, the UE 115-c may be an energy harvesting UE 115 and may transmit an indication of the state of the UE 115-c to a power-providing UE 115. In some other cases, the UE 115-c may be a power providing UE 115 and may receive the transmission from the energy harvesting UE 115 indicating the state of the energy harvesting UE 115.

At 305, the UE 115-c may detect that an energy level of the UE 115-c may be below a threshold. For example, the UE 115-c may detect that the Uu energy harvesting level on the Uu link is lower than a threshold, or there is a radio link failure on the Uu link with the network entity 105. In some other examples, the UE 115-c may detect that the battery level of the UE 115-c or a charging rate of the UE 115-c is lower than a threshold.

At 310, the UE 115-c may determine that one or more conditions have been met to use or monitor the conditional resources for energy harvesting transmissions or for reception of energy signaling. For example, the UE 115-c may determine that the battery level or charging rate detected at 305, is below a given threshold such as a battery percentage or a charging rate threshold. In some such cases, the UE 115-c may have access to a first resource pool once a first battery percentage or charging rate falls below a first threshold, and may have access to a second resource pool once its battery percentage or charging rate falls below a second threshold. In some other examples, the UE 115-c may not be configured with dedicated sidelink harvesting with known periodic resources (e.g., mode 1 sidelink communications). In some such examples, at 310, the UE 115-c may detect an energy or charging rate drop over a time duration of a time window, and the UE 115-c may compare the energy or charging rate drop to a threshold for the time window. In examples where the energy or charging rate drop may be higher than the threshold for the time window, the condition to use the conditional resource pool may be met, and the UE 115-c may access the conditional resource pool.

In some other examples, the UE 115-c may receive an indication that a number of power-providing UEs 115 (e.g., energy-peer UEs 115) that are using the standard or primary resource pool for energy transfers is below a threshold. As such, using the standard resource pool may less efficient than use of the conditional resource pool, so the UE 115-c may use the conditional resource pool to support an improved energy transfer for the UE 115-c. Additionally or alternatively, the UE 115-c may receive signaling that a number of power-providing UEs 115 available in the conditional resource pool for energy transfers is above a threshold, and the UE 115-c may have access to the conditional resource pool to receive energy from the power providing UEs.

In some other cases, the UE 115-c may receive an urgent or high priority data request from another UE 115 or the network entity 105, such as an ultra-reliable low-latency communications (URLLC) data request. In such cases, if the UE 115-c battery status or charging rate is below a threshold at the given time of the request, the UE 115-c may access the conditional resource pools to receive energy signaling so that the UE 115-c has enough power to transmit the urgent/high priority request (which may consume a large amount of power from the UE 115-c). For example, the battery level and the charging rate of the UE 115-c may be below the threshold (e.g., the charging rate may not charge the UE 115-c fast enough to support the power consumption of the data request), and a flag may be raised to use the conditional resources to charge the UE 115-c in preparation for the urgent/high priority data request.

In some other examples, the UE 115-c may access the conditional resource pools based on a predicted energy status or a predicted change to an energy profile of the UE 115-c over time. For example, the energy profile of the UE 115-c may include a current energy state and a predicted energy state over one or more time durations. If the energy state prediction is below an energy state threshold, then the UE 115-c may access the conditional resource pools for receiving energy signaling. The energy profile of the UE 115-c may also include a current charging rate and a predicted charging rate over one or more time durations. The UE 115-c may predict a future discharging rate based on current discharging rate or power consumption, and if the predicted discharging rate is higher than a threshold discharging rate, the UE 115-c may access the conditional resource pools for receiving energy signaling. In some examples, the UE 115-c may use one or more energy harvesting techniques (e.g., radio frequency, solar, thermal, or other techniques) to measure the current charging rate and predict the future charging rate. The energy profile of the UE 115-c may also include a current discharging rate and a predicted discharging rate over one or more time durations. For example, the UE 115-c may predict a future discharging rate based on current discharging rate or power consumption from battery leakage or storage unit leakage, scheduling of uplink, downlink, or sidelink communications, or monitoring power parameters.

In some examples, the UE 115-c may input one or more current or estimated parameters to a function, table (e.g., by L1/L2/L3), a machine learning (ML) model, a mapping function, or may use other techniques in order to determine which resource pools to utilize. In some examples, the UE 115-c may periodically select or reselect different resource pools to use based on such techniques. For example, the UE 115-c may determine which resource pools to use, and a sequence of time to use resource pools. In examples where the UE 115-c determines different times to use different resource pools, the UE 115-c may update timing based on various L1/L2/L3 parameters or based on satisfying a threshold condition (e.g., a threshold priority, a threshold number of energy sources in current resources or exceptional resources, a threshold battery power or link power, among other threshold conditions).

In some other examples, the UE 115-c may receive signaling from the network entity which instructs the UE 115-c of one or more conditional resources or sub-bands that are available for the UE 115-c to use. Additionally or alternatively, the network entity may indicate a ranking or ordering of the conditional resource pools or sub-bands, and the UE 115-c may use this ranking or ordering when determining which conditional resource pool or sub-band to access.

In such examples, the conditions to use the conditional resources may be met by the energy harvesting UE 115 and may be detected by either the energy harvesting UE 115 or another power-providing UE 115. In cases where the UE 115-c may be an energy harvesting UE 115, the UE 115-c may detect that the condition to use or monitor the conditional resources may be met based at least on the current state of the UE 115-c at 305. In cases where the UE 115-c may be a power-providing UE 115, the UE 115-c may detect that the condition to use or monitor the conditional resource pool has been met based at least on the transmitted indication of the state of the energy harvesting UE 115 at 305. For example, the power-providing UE 115 may receive a message from the energy harvesting UE or from the network entity which notifies the power-providing UE 115 of requested energy signaling.

At 315, the UE 115-c may transmit or receive energy signaling via the conditional resources. In cases where the UE 115-c may be an energy harvesting UE 115, the UE 115-c, upon meeting the criteria or threshold conditions at 310, may receive or request energy from a power-providing UE 115 using the conditional resources. In cases where the UE 115-c may be a power providing UE 115, the UE 115-c may transmit energy signaling or receive a request to transmit energy signaling via the conditional resources to the energy harvesting UE 115.

At 320, in cases where the UE 115-c may be an energy harvesting UE 115, the UE 115-c may have received the energy signaling from a power providing UE 115. For example, if at 305, the UE 115-c detected that the battery level or charging rate was below a threshold, following receiving the energy at 315, the UE 115-c battery level or charging rate may be at or above the threshold at 320.

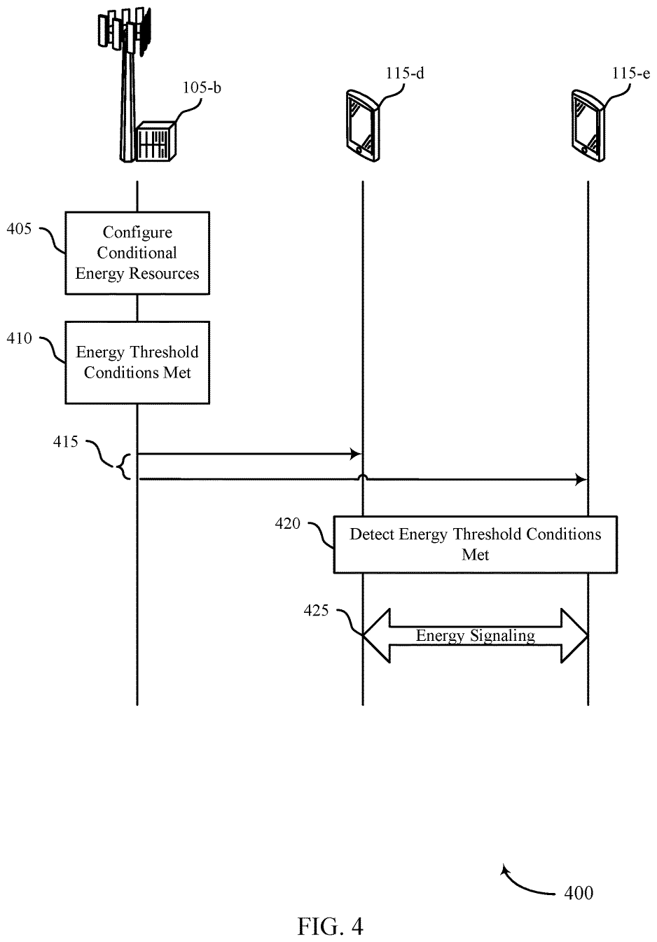

The techniques described herein may support the UEs 115 in improved service reliability and battery life. For example, the UE 115-c may use the conditional resources in “extraordinary” or conditional situations described herein which may allow for enhanced use of the transmission resource pool for sidelink communications between UEs 115 and communications on the Uu link between a UE 115 and the network entity 105. Additional conditional situations and uses of the conditional resources may be described herein, including with reference to FIG. 4.

FIG. 4 illustrates an example of a process flow 400 that supports exceptional resources for energy harvesting devices in accordance with one or more aspects of the present disclosure. In some examples, the process flow 400 may implement aspects of the wireless communications system 100 or 200 or may be implemented by aspects of the wireless communications system 100 or 200. For example, the process flow 400 may include a UE 115-d, a UE 115-e, and a network entity 105-b, which may be examples of corresponding devices described herein. In some examples, a first wireless device and a second wireless device may be examples of the UEs 115 herein where the first wireless device and the second wireless device may be examples of the UE 115-d or the UE 115-c. Alternative examples of the following process flow may be implemented, where some steps are performed in a different order than described or are not performed at all. In some cases, steps may include additional features not mentioned below, or further steps may be added.

At 405, the network entity 105-b may configure a set of conditional resources to be available for transmission of energy signaling to one or more wireless devices (e.g., such as the UE 115-d and the UE 115-e), reception of energy signaling between the one or more wireless devices, or both, based on one or more energy threshold conditions being satisfied. In some cases, the set of conditional energy resources may include a set of one or more sub-bands, one or more resource pools, and may be available for use by the first wireless device (e.g., the UE 115-d) and the second wireless device (e.g., the UE 115-e). At 410, the network entity 105-b may detect that one or more energy conditions have been satisfied at the one or more wireless devices.

At 415, the network entity 105-b may transmit a control message to the one or more wireless devices (e.g., the UE 115-d and the UE 115-e) that indicates that the set of conditional energy resources may be available for use. A first wireless device (e.g., the UE 115-d) may receive the control message, from the network entity 105-b, indicating that the set of conditional energy resources may be available to receive energy transmitted from a second wireless device (e.g., the UE 115-e) based on one or more energy threshold conditions.

In some cases, the first wireless device may receive an indication of a ranking for one or more conditional resources of the set of conditional energy resources available for use by the first wireless device. Additionally or alternatively, the first wireless device may also receive an instruction message at 415 that instructs the first wireless device to use the set of conditional energy resources.

In some examples, the control message, received by the first wireless device (e.g., the UE 115-d) and the second wireless device (UE 115-e) from the network entity 105-b, may include a MIB, a SIB, a RRC message, and assistance information message, a layer indication message, or any combination thereof. In some other examples, the control message may include a unicast configuration message, a broadcast configuration message, a multicast configuration message, or any combination thereof. In some cases, the set of conditional energy resources available for use by the first wireless device to receive the energy signaling from the second wireless device may be different from a second set of one or more resources available for use by the first wireless device. In some examples, the second set of one or more resources may be used by the first wireless device to receive data messaging, control messaging, or both from the second wireless device.

At 420, the first wireless device, the second wireless device, or both may detect that the one or more energy threshold conditions have been satisfied. Based at least on the one or more energy thresholds being satisfied at the first wireless device, the second wireless device, or both, the first wireless device may receive, from the second wireless device, the energy signaling via the set of conditional energy resources at 425. In some cases, the first wireless device may receive the energy signaling via the set of conditional energy resources at 425 based on the ranking of the set of conditional resources received, at 415. Additionally or alternatively, the ranking may indicate an availability of the one or more conditional energy resources of the set of conditional energy resources.

In some examples, based on the one or more energy threshold conditions being satisfied, at 420, the first wireless device may receive, from the second wireless device, the energy signaling via the set of one or more resource pools, the set of one or more sub-bands, or both, at 425. In some cases, a selection of the one or more resource pools, the one or more sub-bands, or both may be based on the one or more energy threshold conditions being satisfied at 420.

In some cases, the one or more energy threshold conditions being satisfied at 420 may include an energy threshold associated with a communication link between the first wireless device (e.g., the UE 115-d) and the network entity 105-b. As such, the first wireless device may receive the energy signaling, from the second wireless device at 425 based at least in on an energy threshold associated with the communication link being lower than the energy threshold, a radio link failure on the communication link, or both.

In some examples, the one or more energy threshold conditions being satisfied at 420 may include a battery level threshold, a charging rate threshold, or both at the first wireless device. In some cases, first wireless device may receive the energy signaling via the set of conditional energy resources, from the second wireless device, at 425, based at least on the second wireless device receiving an indication, from the first wireless device, that a battery level of the first wireless device may be lower than the battery level threshold, a charging rate of the first wireless device may be lower than the charging rate threshold, or both. In some other examples, the one or more energy threshold conditions satisfied at 420 may include a threshold charging rate of the first wireless device over a time duration. In some cases, the first wireless device may estimate a future charging rate based on the current charging rate of the first wireless device and receive the energy signaling via the set of conditional energy resources, at 425, based on the estimated future charging rate of the first wireless device being less than the threshold charging rate. In some other examples, the one or more energy threshold being conditions satisfied at 420 may include a threshold power consumption rate of the first wireless device over a time duration. In some examples, the first wireless device may estimate a future power consumption rate based at least on the current power consumption rate and receive the energy signaling via the set of conditional resources, at 425, based at least on the estimated power consumption rate for the first wireless device being less than the threshold power consumption rate.

In such examples the one or more energy thresholds satisfied at 420 may include a battery level threshold, charging rate threshold, a power consumption threshold, or any combination thereof. In some cases, the first wireless device may receive a message requesting transmission of one or more high priority data messages to be transmitted from the first wireless device to the second wireless device. Additionally or alternatively, the second wireless device may receive a message indicating that the first wireless device has one or more high priority data messages to transmit. As such, the first wireless device may receive the energy signaling via the set of conditional resources, at 425, from the second wireless device based at least on a battery level of the first wireless device being lower than the battery threshold, a charging rate of the second wireless device being lower than the charging rate threshold, a power consumption of the second wireless device being greater than the power consumption threshold, or any combination thereof. Further, the first wireless device may transmit the one or more high priority messages based at least on receiving the energy signaling from the second wireless device, at 425.

In some implementations, the one or more energy thresholds satisfied at 420 may include a threshold quantity of energy providing wireless devices (e.g., UEs 115) associated with a second set of energy resources. In some cases, the first wireless device may receive the energy signaling via the set of conditional energy resources, from the second wireless device, at 425, based on a quantity of energy providing wireless devices associated with the second set of energy resources being below the threshold quantity of energy providing wireless devices. In some other implementations, the one or more energy thresholds satisfied at 420 may include a threshold quantity of energy providing wireless devices associated with the set of conditional energy resources. In such examples, the first wireless device may receive the energy signaling via the set of conditional energy resources, at 425, based on a quantity of energy providing wireless devices associated with the set of conditional energy resources exceeding the threshold of energy providing wireless devices.

In some examples, the one or more energy threshold conditions satisfied at 420 may include a threshold corresponding to a reduction in energy of the first wireless device over a time duration. In some cases, the first wireless device may receive the energy signaling via the set of conditional energy resources, at 425, from the second wireless device based at least on receiving an indication from the first wireless device that the reduction in the energy of the first wireless device over the time duration exceeds the threshold. In some other examples, the one or more energy threshold conditions satisfied at 420 may include a threshold decrease in a predicted energy state of the first wireless device over a time duration. Then the first wireless device may receive the energy signaling via the set of conditional energy resources, at 425, based at least on the predicted energy state of the first wireless device decreasing an amount greater than the threshold decrease.

In such examples and implementations, the first wireless device may receive the energy signaling, from the second wireless device, via a first resource of the set of conditional energy resources, at 425, based on a first threshold of the one or more energy thresholds being satisfied, at 420. In some other cases, the first wireless device may receive the energy signaling, from the second wireless device, via a second resource of the set of conditional energy resources, at 425, based at least on a second threshold of the one or more energy thresholds being satisfied, at 420.

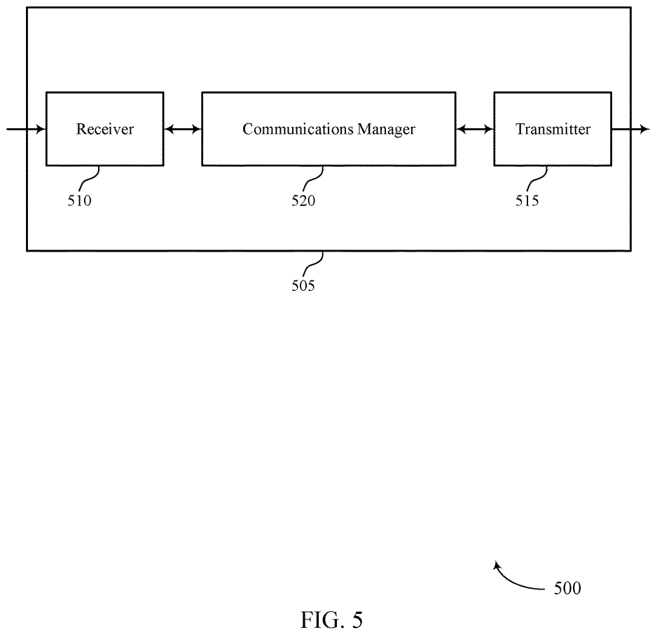

FIG. 5 shows a block diagram 500 of a device 505 that supports exceptional resources for energy harvesting devices in accordance with one or more aspects of the present disclosure. The device 505 may be an example of aspects of a UE 115 as described herein. The device 505 may include a receiver 510, a transmitter 515, and a communications manager 520. The device 505 may also include at least one processor. Each of these components may be in communication with one another (e.g., via one or more buses).

The receiver 510 may provide a means for receiving information such as packets, user data, control information, or any combination thereof associated with various information channels (e.g., control channels, data channels, information channels related to exceptional resources for energy harvesting devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to exceptional resources for energy harvesting devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of exceptional resources for energy harvesting devices as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include at least one processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with at least one processor may be configured to perform one or more of the functions described herein (e.g., by executing, by the at least one processor, instructions stored in the memory).

Additionally, or alternatively, in some examples, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first wireless device in accordance with examples as disclosed herein. For example, the communications manager 520 may be configured as or otherwise support a means for receiving a control message that indicates a set of conditional energy resources available for use by the first wireless device to receive energy signaling from a second wireless device based on one or more energy threshold conditions. The communications manager 520 may be configured as or otherwise support a means for detecting that the one or more energy threshold conditions have been satisfied at the first wireless device. The communications manager 520 may be configured as or otherwise support a means for receiving the energy signaling via the set of conditional energy resources based on the one or more energy threshold conditions being satisfied at the first wireless device.

Additionally, or alternatively, the communications manager 520 may support wireless communications at a first wireless device in accordance with examples as disclosed herein. For example, the communications manager 520 may be configured as or otherwise support a means for receiving a control message that indicates a set of conditional energy resources available for use by the first wireless device to transmit energy signaling to a second wireless device based on one or more energy threshold conditions. The communications manager 520 may be configured as or otherwise support a means for detecting that the one or more energy threshold conditions have been satisfied at the first wireless device, at the second device, or both. The communications manager 520 may be configured as or otherwise support a means for transmitting the energy signaling via the set of conditional energy resources based on the one or more energy threshold conditions being satisfied at the first wireless device, the second wireless device, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for relatively more efficient power consumption, more efficient utilization of communication resources including conditional or exceptional resources, and enhanced battery life and charging techniques.

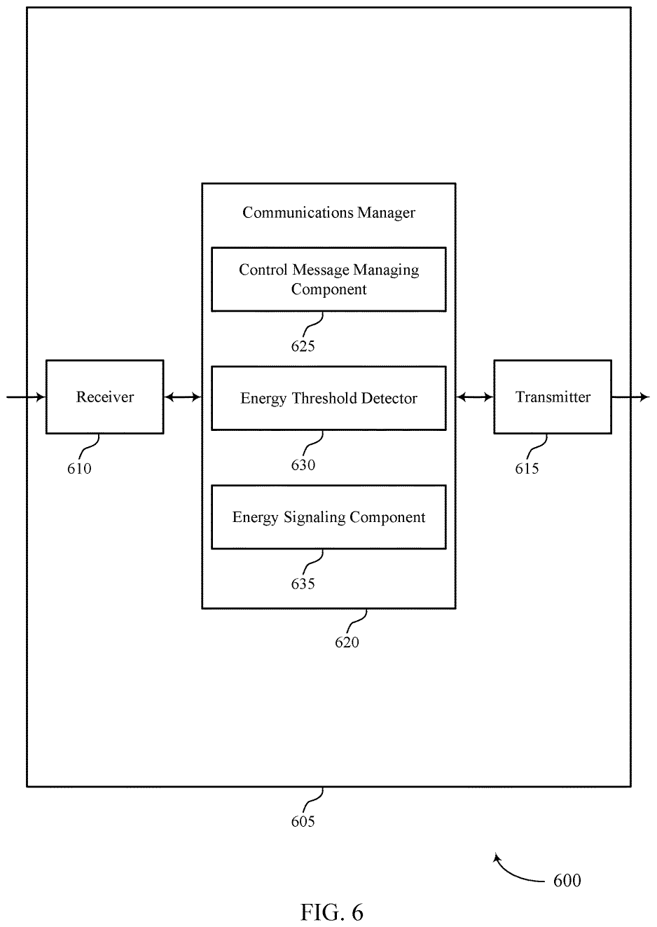

FIG. 6 shows a block diagram 600 of a device 605 that supports exceptional resources for energy harvesting devices in accordance with one or more aspects of the present disclosure. The device 605 may be an example of aspects of a device 505 or a UE 115 as described herein. The device 605 may include a receiver 610, a transmitter 615, and a communications manager 620. The device 605 may also include at least one processor. Each of these components may be in communication with one another (e.g., via one or more buses).

The receiver 610 may provide a means for receiving information such as packets, user data, control information, or any combination thereof associated with various information channels (e.g., control channels, data channels, information channels related to exceptional resources for energy harvesting devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to exceptional resources for energy harvesting devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of exceptional resources for energy harvesting devices as described herein. For example, the communications manager 620 may include a control message managing component 625, an energy threshold detector 630, an energy signaling component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first wireless device in accordance with examples as disclosed herein. The control message managing component 625 may be configured as or otherwise support a means for receiving a control message that indicates a set of conditional energy resources available for use by the first wireless device to receive energy signaling from a second wireless device based on one or more energy threshold conditions. The energy threshold detector 630 may be configured as or otherwise support a means for detecting that the one or more energy threshold conditions have been satisfied at the first wireless device. The energy signaling component 635 may be configured as or otherwise support a means for receiving the energy signaling via the set of conditional energy resources based on the one or more energy threshold conditions being satisfied at the first wireless device.

Additionally, or alternatively, the communications manager 620 may support wireless communications at a first wireless device in accordance with examples as disclosed herein. The control message managing component 625 may be configured as or otherwise support a means for receiving a control message that indicates a set of conditional energy resources available for use by the first wireless device to transmit energy signaling to a second wireless device based on one or more energy threshold conditions. The energy threshold detector 630 may be configured as or otherwise support a means for detecting that the one or more energy threshold conditions have been satisfied at the first wireless device, at the second device, or both. The energy signaling component 635 may be configured as or otherwise support a means for transmitting the energy signaling via the set of conditional energy resources based on the one or more energy threshold conditions being satisfied at the first wireless device, the second wireless device, or both.

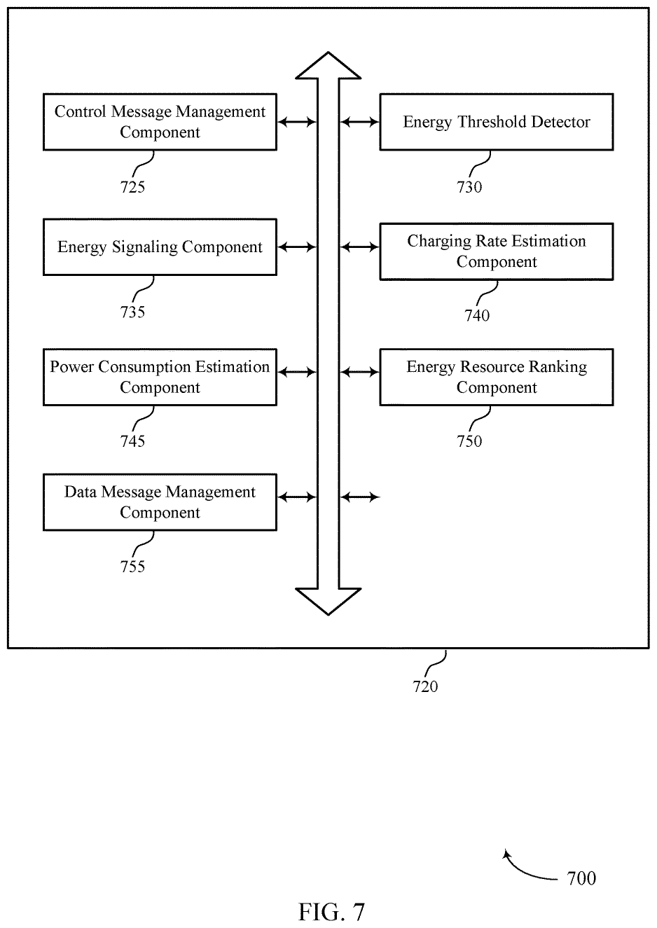

FIG. 7 shows a block diagram 700 of a communications manager 720 that supports exceptional resources for energy harvesting devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of exceptional resources for energy harvesting devices as described herein. For example, the communications manager 720 may include a control message management component 725, an energy threshold detector 730, an energy signaling component 735, a charging rate estimation component 740, a power consumption estimation component 745, an energy resource ranking component 750, a data message management component 755, or any combination thereof. Each of these components may communicate, directly or indirectly, with one another (e.g., via one or more buses).

The communications manager 720 may support wireless communications at a first wireless device in accordance with examples as disclosed herein. The control message management component 725 may be configured as or otherwise support a means for receiving a control message that indicates a set of conditional energy resources available for use by the first wireless device to receive energy signaling from a second wireless device based on one or more energy threshold conditions. The energy threshold detector 730 may be configured as or otherwise support a means for detecting that the one or more energy threshold conditions have been satisfied at the first wireless device. The energy signaling component 735 may be configured as or otherwise support a means for receiving the energy signaling via the set of conditional energy resources based on the one or more energy threshold conditions being satisfied at the first wireless device.

In some examples, the set of conditional energy resources includes a set of one or more resource pools available for use by the first wireless device, and the energy signaling component 735 may be configured as or otherwise support a means for receiving, from the second wireless device, the energy signaling via the set of one or more resource pools, where a selection of the set of one or more resource pools is based on the one or more energy threshold conditions being satisfied.

In some examples, the set of conditional energy resources includes a set of one or more sub-bands available for use by the first wireless device, and the energy signaling component 735 may be configured as or otherwise support a means for receiving, from the second wireless device, the energy signaling via the set of one or more sub-bands, where a selection of the set of one or more sub-bands is based on the one or more energy threshold conditions being satisfied.

In some examples, the one or more energy threshold conditions include an energy threshold associated with a communication link between the first wireless device and a network entity, and the energy signaling component 735 may be configured as or otherwise support a means for receiving the energy signaling via the set of conditional energy resources based on one or more of: an energy level associated with the communication link being lower than the energy threshold, a radio link failure on the communication link, or both.

In some examples, the one or more energy threshold conditions include a battery level threshold at the first wireless device, and the energy signaling component 735 may be configured as or otherwise support a means for receiving the energy signaling via the set of conditional energy resources based on a battery level of the first wireless device being lower than the battery level threshold.

In some examples, the one or more energy threshold conditions include a charging rate threshold at the first wireless device, and the energy signaling component 735 may be configured as or otherwise support a means for receiving the energy signaling via the set of conditional energy resources based on a charging rate of the first wireless device being lower than the charging rate threshold.

In some examples, the one or more energy threshold conditions include a threshold quantity of energy providing wireless devices associated with a second set of energy resources, and the energy signaling component 735 may be configured as or otherwise support a means for receiving the energy signaling via the set of conditional energy resources based on a quantity of energy providing wireless devices associated with the second set of energy resources being below the threshold quantity of energy providing wireless devices.

In some examples, the one or more energy threshold conditions include a threshold quantity of energy providing wireless devices associated with the set of conditional energy resources, and the energy signaling component 735 may be configured as or otherwise support a means for receiving the energy signaling via the set of conditional energy resources based on a quantity of energy providing wireless devices associated with the set of conditional energy resources exceeding the threshold quantity of energy providing wireless devices.

In some examples, the one or more energy threshold conditions include a threshold corresponding to a reduction in energy of the first wireless device over a time duration, and the energy signaling component 735 may be configured as or otherwise support a means for receiving the energy signaling via the set of conditional energy resources based on the reduction in the energy of the first wireless device over the time duration exceeding the threshold.

In some examples, the one or more energy threshold conditions include a threshold decrease in a predicted energy state of the first wireless device over a time duration, and the energy signaling component 735 may be configured as or otherwise support a means for receiving the energy signaling via the set of conditional energy resources based on the predicted energy state of the first wireless device decreasing an amount greater than the threshold decrease.

In some examples, the one or more energy threshold conditions include a threshold charging rate of the first wireless device over a time duration, and the charging rate estimation component 740 may be configured as or otherwise support a means for estimating a future charging rate of the first wireless device based on a current charging rate of the first wireless device. In some examples, the one or more energy threshold conditions include a threshold charging rate of the first wireless device over a time duration, and the energy signaling component 735 may be configured as or otherwise support a means for receiving the energy signaling via the set of conditional energy resources based on the estimated future charging rate of the first wireless device being less than the threshold charging rate.

In some examples, the one or more energy threshold conditions include a threshold power consumption rate of the first wireless device over a time duration, and the power consumption estimation component 745 may be configured as or otherwise support a means for estimating a future power consumption rate of the first wireless device based on a current power consumption rate of the first wireless device. In some examples, the one or more energy threshold conditions include a threshold power consumption rate of the first wireless device over a time duration, and the energy signaling component 735 may be configured as or otherwise support a means for receiving the energy signaling via the set of conditional energy resources based on the estimated future power consumption rate of the first wireless device being less than the threshold power consumption rate.

In some examples, the energy resource ranking component 750 may be configured as or otherwise support a means for receiving an indication of a ranking for one or more conditional energy resources of the set of conditional energy resources available for use by the first wireless device. In some examples, the energy signaling component 735 may be configured as or otherwise support a means for receiving the energy signaling via at least one conditional energy resource of the one or more conditional energy resources based on the ranking, where the ranking indicates an availability of the one or more conditional energy resources.

In some examples, the one or more energy threshold conditions include a battery level threshold of the first wireless device, and the control message management component 725 may be configured as or otherwise support a means for receiving a message requesting transmission of one or more high priority data messages from the first wireless device to the second wireless device. In some examples, the one or more energy threshold conditions include a battery level threshold of the first wireless device, and the energy signaling component 735 may be configured as or otherwise support a means for receiving the energy signaling via the set of conditional energy resources based on a battery level of the first wireless device being lower than the battery level threshold, a charging rate of the first wireless device being lower than the charging rate threshold, a power consumption of the first wireless device being greater than the power consumption threshold, or any combination thereof. In some examples, the one or more energy threshold conditions include a battery level threshold of the first wireless device, and the data message management component 755 may be configured as or otherwise support a means for transmitting the one or more high priority data messages to the second wireless device based on the received energy signaling.

In some examples, the control message management component 725 may be configured as or otherwise support a means for receiving an instruction message that instructs the first wireless device to use the set of conditional energy resources.

In some examples, the energy signaling component 735 may be configured as or otherwise support a means for receiving the energy signaling via a first resource of the set of conditional energy resources based on a first threshold of the one or more energy threshold conditions being satisfied. In some examples, the energy signaling component 735 may be configured as or otherwise support a means for receiving the energy signaling via a second resource of the set of conditional energy resources based on a second threshold of the one or more energy threshold conditions being satisfied.

In some examples, the control message includes a master information block, a system information block, a radio resource control message, an assistance information message, a layer indication message, or any combination thereof.

In some examples, the control message includes a unicast configuration message, a broadcast configuration message, a multicast configuration message, or any combination thereof.

In some examples, the set of conditional energy resources available for use by the first wireless device to receive the energy signaling from the second wireless device is different from a second set of one or more resources available for use by the first wireless device to receive data messaging, control messaging, or both, from the second wireless device.

Additionally, or alternatively, the communications manager 720 may support wireless communications at a first wireless device in accordance with examples as disclosed herein. The control message management component 725 may be configured as or otherwise support a means for receiving a control message that indicates a set of conditional energy resources available for use by the first wireless device to transmit energy signaling to a second wireless device based on one or more energy threshold conditions. In some examples, the energy threshold detector 730 may be configured as or otherwise support a means for detecting that the one or more energy threshold conditions have been satisfied at the first wireless device, at the second device, or both. The energy signaling component 735 may be configured as or otherwise support a means for transmitting the energy signaling via the set of conditional energy resources based on the one or more energy threshold conditions being satisfied at the first wireless device, the second wireless device, or both.

In some examples, the set of conditional energy resources includes a set of one or more sub-bands available for use by the first wireless device, and the energy signaling component 735 may be configured as or otherwise support a means for transmitting, to the second wireless device, the energy signaling via the set of one or more sub-bands, the one or more resource pools, or both, based on the one or more energy threshold conditions being satisfied.

In some examples, the one or more energy threshold conditions include an energy threshold associated with a communication link between the second wireless device and a network entity, and the energy signaling component 735 may be configured as or otherwise support a means for transmitting the energy signaling via the set of conditional energy resources based on one or more of: an energy level associated with the communication link being lower than the energy threshold, a radio link failure on the communication link, or both.

In some examples, the one or more energy threshold conditions include a battery level threshold at the second wireless device, and the control message management component 725 may be configured as or otherwise support a means for receiving an indication that a battery level of the second wireless device is lower than the battery level threshold, a charging rate of the second wireless device is lower than the charging rate threshold, or both. In some examples, the one or more energy threshold conditions include a battery level threshold at the second wireless device, and the energy signaling component 735 may be configured as or otherwise support a means for transmitting the energy signaling via the set of conditional energy resources based on the indication that the battery level of the second wireless device is lower than the battery level threshold, the charging rate of the second wireless device is lower than the charging rate threshold, or both.

In some examples, the one or more energy threshold conditions include a threshold quantity of energy providing wireless devices associated with a second set of energy resources, and the energy signaling component 735 may be configured as or otherwise support a means for transmitting the energy signaling via the set of conditional energy resources based on a quantity of energy providing wireless devices associated with the second set of energy resources being below the threshold quantity of energy providing wireless devices.

In some examples, the one or more energy threshold conditions include a threshold quantity of energy providing wireless devices associated with the set of conditional energy resources, and the energy signaling component 735 may be configured as or otherwise support a means for transmitting the energy signaling via the set of conditional energy resources based on a quantity of energy providing wireless devices associated with the set of conditional energy resources exceeding the threshold quantity of energy providing wireless devices.

In some examples, the one or more energy threshold conditions include a threshold corresponding to a reduction in energy of the second wireless device over a time duration, and the control message management component 725 may be configured as or otherwise support a means for receiving an indication that the reduction in energy of the second wireless device over the time duration exceeds the threshold. In some examples, the one or more energy threshold conditions include a threshold corresponding to a reduction in energy of the second wireless device over a time duration, and the energy signaling component 735 may be configured as or otherwise support a means for transmitting the energy signaling via the set of conditional energy resources based on the reduction in the energy of the second wireless device over the time duration exceeding the threshold.

In some examples, the one or more energy threshold conditions include a battery level threshold of the second wireless device, and the control message management component 725 may be configured as or otherwise support a means for receiving a message indicating that the second wireless device has one or more high priority data messages to transmit. In some examples, the one or more energy threshold conditions include a battery level threshold of the second wireless device, and the energy signaling component 735 may be configured as or otherwise support a means for transmitting the energy signaling via the set of conditional energy resources based on a battery level of the second wireless device being lower than the battery level threshold, a charging rate of the second wireless device being lower than the charging rate threshold, a power consumption of the first wireless device being greater than the power consumption threshold, or any combination thereof.

In some examples, the energy signaling component 735 may be configured as or otherwise support a means for transmitting the energy signaling via a first resource of the set of conditional energy resources based on a first threshold of the one or more energy threshold conditions being satisfied. In some examples, the energy signaling component 735 may be configured as or otherwise support a means for transmitting the energy signaling via a second resource of the set of conditional energy resources based on the one or more energy threshold conditions being satisfied.

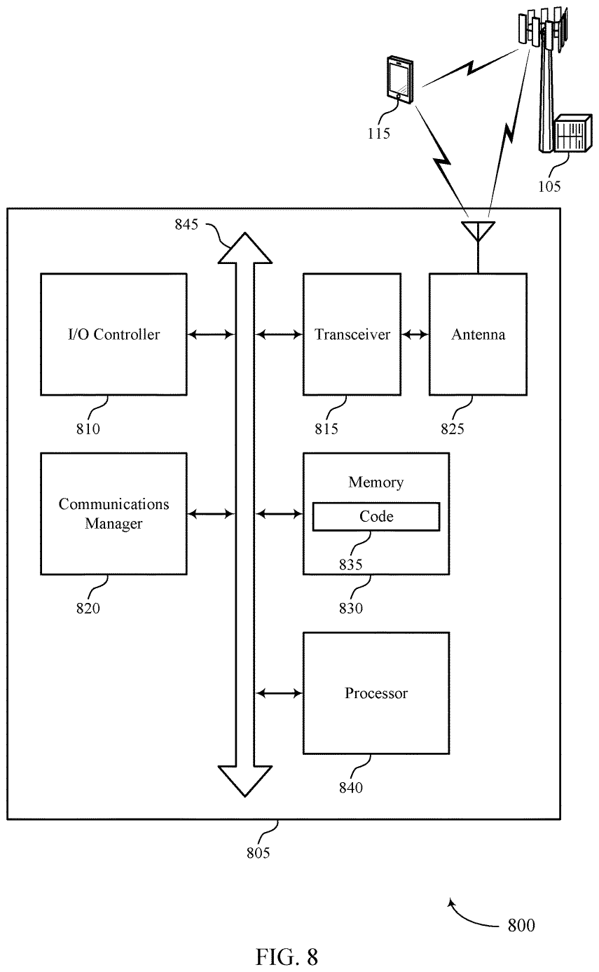

FIG. 8 shows a diagram of a system 800 including a device 805 that supports exceptional resources for energy harvesting devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of at least one processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting exceptional resources for energy harvesting devices). For example, the device 805 or a component of the device 805 may include at least one processor 840 and memory 830 coupled with or to the processor 840, the processor 840 and memory 830 configured to perform various functions described herein.

The communications manager 820 may support wireless communications at a first wireless device in accordance with examples as disclosed herein. For example, the communications manager 820 may be configured as or otherwise support a means for receiving a control message that indicates a set of conditional energy resources available for use by the first wireless device to receive energy signaling from a second wireless device based on one or more energy threshold conditions. The communications manager 820 may be configured as or otherwise support a means for detecting that the one or more energy threshold conditions have been satisfied at the first wireless device. The communications manager 820 may be configured as or otherwise support a means for receiving the energy signaling via the set of conditional energy resources based on the one or more energy threshold conditions being satisfied at the first wireless device.

Additionally, or alternatively, the communications manager 820 may support wireless communications at a first wireless device in accordance with examples as disclosed herein. For example, the communications manager 820 may be configured as or otherwise support a means for receiving a control message that indicates a set of conditional energy resources available for use by the first wireless device to transmit energy signaling to a second wireless device based on one or more energy threshold conditions. The communications manager 820 may be configured as or otherwise support a means for detecting that the one or more energy threshold conditions have been satisfied at the first wireless device, at the second device, or both. The communications manager 820 may be configured as or otherwise support a means for transmitting the energy signaling via the set of conditional energy resources based on the one or more energy threshold conditions being satisfied at the first wireless device, the second wireless device, or both.

By including or configuring the communications manager 820 in accordance with examples as described herein, the device 805 may support techniques for improved communication reliability (e.g., in exceptional situations where battery power and service continuity is critical), relatively more efficient power consumption, more efficient utilization of communication resources including conditional or exceptional resources, improved coordination between devices, longer battery life, improved utilization of processing capability, and improved charging and energy signaling techniques (e.g., wireless charging techniques).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of exceptional resources for energy harvesting devices as described herein, or the processor 840 and the memory 830 may be otherwise configured to perform or support such operations.

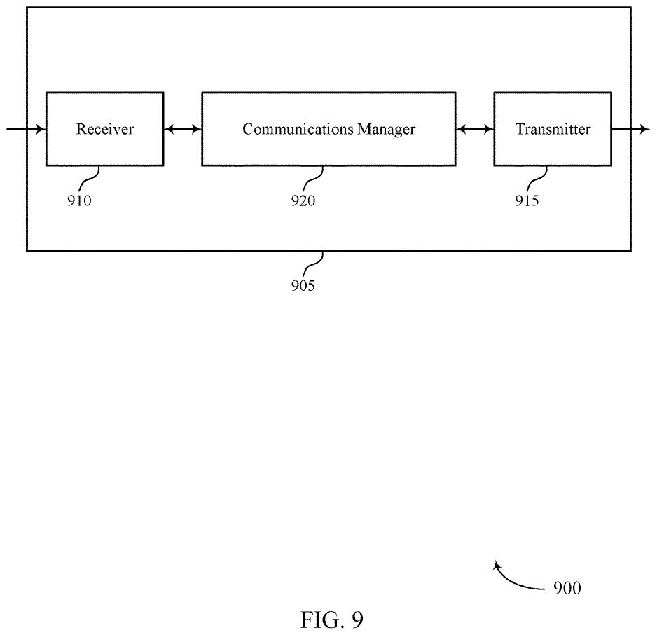

FIG. 9 shows a block diagram 900 of a device 905 that supports exceptional resources for energy harvesting devices in accordance with one or more aspects of the present disclosure. The device 905 may be an example of aspects of a network entity 105 as described herein. The device 905 may include a receiver 910, a transmitter 915, and a communications manager 920. The device 905 may also include at least one processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of exceptional resources for energy harvesting devices as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include at least one processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by at least one processor. If implemented in code executed by at least one processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for configuring a set of conditional energy resources available for transmission of energy signaling to one or more wireless devices, reception of energy signaling between the one or more wireless devices, or both, based on one or more energy threshold conditions being satisfied. The communications manager 920 may be configured as or otherwise support a means for detecting that the one or more energy threshold conditions have been satisfied at the one or more wireless devices. The communications manager 920 may be configured as or otherwise support a means for transmitting a control message to the one or more wireless devices that indicates the set of conditional energy resources.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for relatively more efficient power consumption, more efficient utilization of communication resources including conditional or exceptional resources, and enhanced battery life and charging techniques.

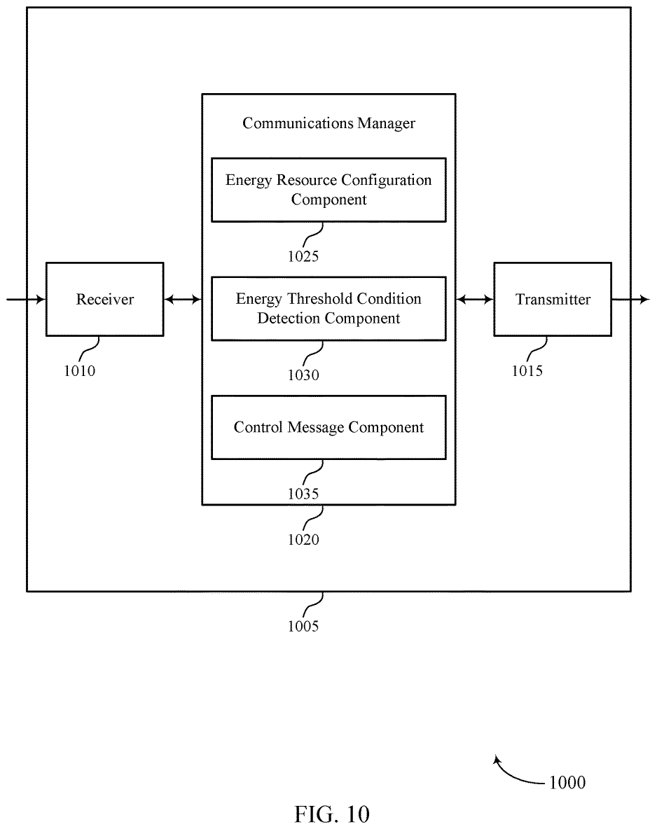

FIG. 10 shows a block diagram 1000 of a device 1005 that supports exceptional resources for energy harvesting devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include at least one processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of exceptional resources for energy harvesting devices as described herein. For example, the communications manager 1020 may include an energy resource configuration component 1025, an energy threshold condition detection component 1030, a control message component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The energy resource configuration component 1025 may be configured as or otherwise support a means for configuring a set of conditional energy resources available for transmission of energy signaling to one or more wireless devices, reception of energy signaling between the one or more wireless devices, or both, based on one or more energy threshold conditions being satisfied. The energy threshold condition detection component 1030 may be configured as or otherwise support a means for detecting that the one or more energy threshold conditions have been satisfied at the one or more wireless devices. The control message component 1035 may be configured as or otherwise support a means for transmitting a control message to the one or more wireless devices that indicates the set of conditional energy resources.

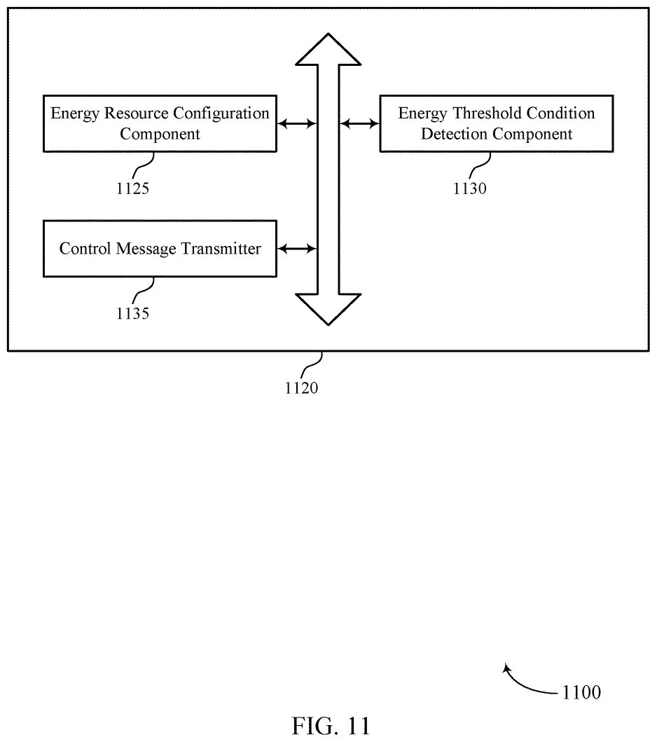

FIG. 11 shows a block diagram 1100 of a communications manager 1120 that supports exceptional resources for energy harvesting devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of exceptional resources for energy harvesting devices as described herein. For example, the communications manager 1120 may include an energy resource configuration component 1125, an energy threshold condition detection component 1130, a control message transmitter 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The energy resource configuration component 1125 may be configured as or otherwise support a means for configuring a set of conditional energy resources available for transmission of energy signaling to one or more wireless devices, reception of energy signaling between the one or more wireless devices, or both, based on one or more energy threshold conditions being satisfied. The energy threshold condition detection component 1130 may be configured as or otherwise support a means for detecting that the one or more energy threshold conditions have been satisfied at the one or more wireless devices. The control message transmitter 1135 may be configured as or otherwise support a means for transmitting a control message to the one or more wireless devices that indicates the set of conditional energy resources.

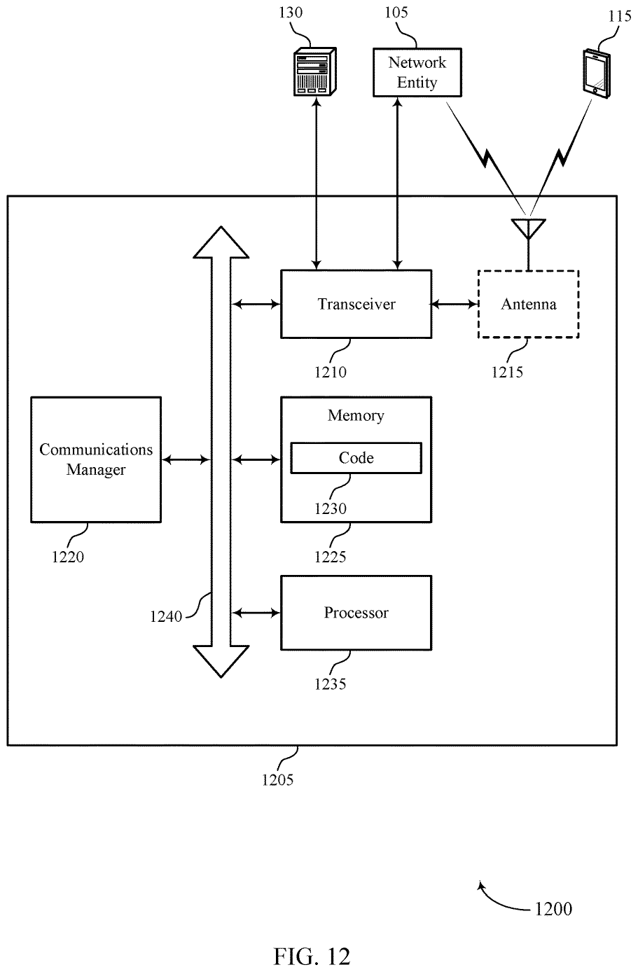

FIG. 12 shows a diagram of a system 1200 including a device 1205 that supports exceptional resources for energy harvesting devices in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting exceptional resources for energy harvesting devices). For example, the device 1205 or a component of the device 1205 may include at least one processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for configuring a set of conditional energy resources available for transmission of energy signaling to one or more wireless devices, reception of energy signaling between the one or more wireless devices, or both, based on one or more energy threshold conditions being satisfied. The communications manager 1220 may be configured as or otherwise support a means for detecting that the one or more energy threshold conditions have been satisfied at the one or more wireless devices. The communications manager 1220 may be configured as or otherwise support a means for transmitting a control message to the one or more wireless devices that indicates the set of conditional energy resources.

By including or configuring the communications manager 1220 in accordance with examples as described herein, the device 1205 may support techniques for improved communication reliability (e.g., in exceptional situations where battery power and service continuity is critical), relatively more efficient power consumption, more efficient utilization of communication resources including conditional or exceptional resources, improved coordination between devices, longer battery life, improved utilization of processing capability, and improved charging and energy signaling techniques (e.g., wireless charging techniques).

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of exceptional resources for energy harvesting devices as described herein, or the processor 1235 and the memory 1225 may be otherwise configured to perform or support such operations.

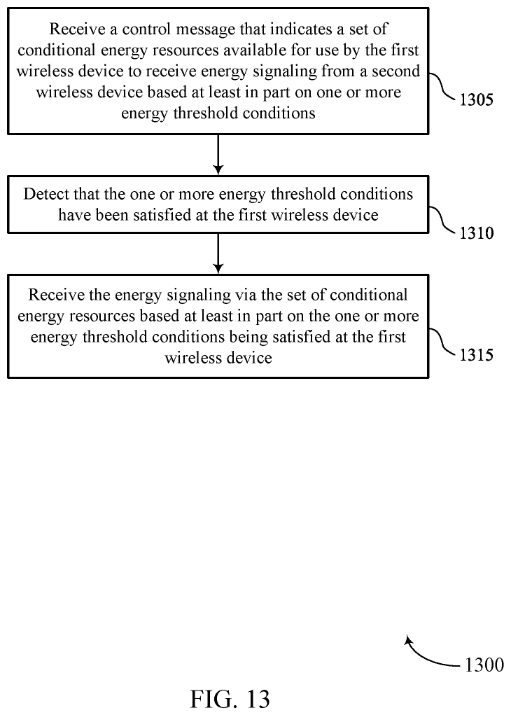

FIG. 13 shows a flowchart illustrating a method 1300 that supports exceptional resources for energy harvesting devices in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message that indicates a set of conditional energy resources available for use by the first wireless device to receive energy signaling from a second wireless device based on one or more energy threshold conditions. The operations of 1305 may be performed in accordance with examples as disclosed herein. In some examples, aspects of the operations of 1305 may be performed by a control message management component 725 as described with reference to FIG. 7.

At 1310, the method may include detecting that the one or more energy threshold conditions have been satisfied at the first wireless device. The operations of 1310 may be performed in accordance with examples as disclosed herein. In some examples, aspects of the operations of 1310 may be performed by an energy threshold detector 730 as described with reference to FIG. 7.

At 1315, the method may include receiving the energy signaling via the set of conditional energy resources based on the one or more energy threshold conditions being satisfied at the first wireless device. The operations of 1315 may be performed in accordance with examples as disclosed herein. In some examples, aspects of the operations of 1315 may be performed by an energy signaling component 735 as described with reference to FIG. 7.

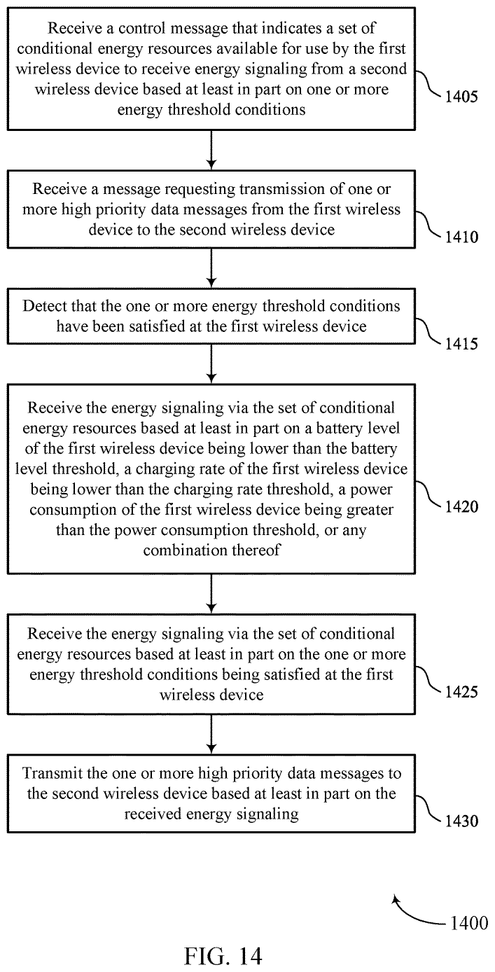

FIG. 14 shows a flowchart illustrating a method 1400 that supports exceptional resources for energy harvesting devices in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message that indicates a set of conditional energy resources available for use by the first wireless device to receive energy signaling from a second wireless device based on one or more energy threshold conditions. The operations of 1405 may be performed in accordance with examples as disclosed herein. In some examples, aspects of the operations of 1405 may be performed by a control message management component 725 as described with reference to FIG. 7.

At 1410, the method may include receiving a message requesting transmission of one or more high priority data messages from the first wireless device to the second wireless device. The operations of 1410 may be performed in accordance with examples as disclosed herein. In some examples, aspects of the operations of 1410 may be performed by a control message management component 725 as described with reference to FIG. 7.

At 1415, the method may include detecting that the one or more energy threshold conditions have been satisfied at the first wireless device. The operations of 1415 may be performed in accordance with examples as disclosed herein. In some examples, aspects of the operations of 1415 may be performed by an energy threshold detector 730 as described with reference to FIG. 7.

At 1420, the method may include receiving the energy signaling via the set of conditional energy resources based on a battery level of the first wireless device being lower than the battery level threshold, a charging rate of the first wireless device being lower than the charging rate threshold, a power consumption of the first wireless device being greater than the power consumption threshold, or any combination thereof. The operations of 1420 may be performed in accordance with examples as disclosed herein. In some examples, aspects of the operations of 1420 may be performed by an energy signaling component 735 as described with reference to FIG. 7.

At 1425, the method may include receiving the energy signaling via the set of conditional energy resources based on the one or more energy threshold conditions being satisfied at the first wireless device. The operations of 1425 may be performed in accordance with examples as disclosed herein. In some examples, aspects of the operations of 1425 may be performed by an energy signaling component 735 as described with reference to FIG. 7.

At 1430, the method may include transmitting the one or more high priority data messages to the second wireless device based on the received energy signaling. The operations of 1430 may be performed in accordance with examples as disclosed herein. In some examples, aspects of the operations of 1430 may be performed by a data message management component 755 as described with reference to FIG. 7.

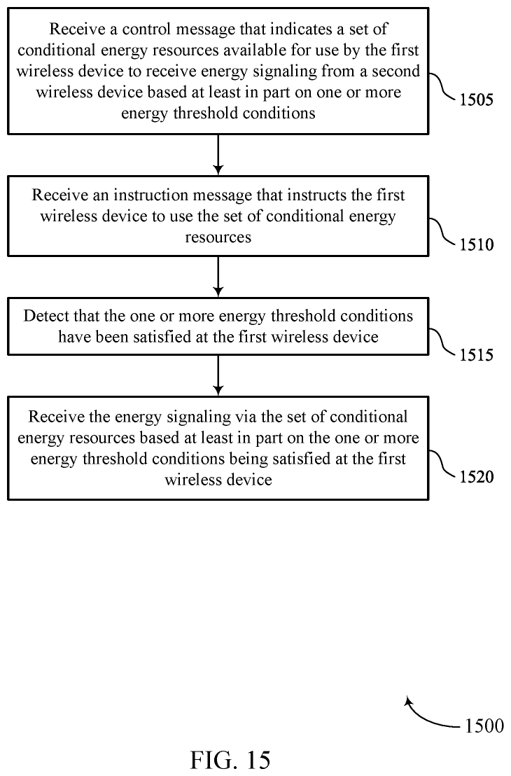

FIG. 15 shows a flowchart illustrating a method 1500 that supports exceptional resources for energy harvesting devices in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message that indicates a set of conditional energy resources available for use by the first wireless device to receive energy signaling from a second wireless device based on one or more energy threshold conditions. The operations of 1505 may be performed in accordance with examples as disclosed herein. In some examples, aspects of the operations of 1505 may be performed by a control message management component 725 as described with reference to FIG. 7.

At 1510, the method may include receiving an instruction message that instructs the first wireless device to use the set of conditional energy resources. The operations of 1510 may be performed in accordance with examples as disclosed herein. In some examples, aspects of the operations of 1510 may be performed by a control message management component 725 as described with reference to FIG. 7.

At 1515, the method may include detecting that the one or more energy threshold conditions have been satisfied at the first wireless device. The operations of 1515 may be performed in accordance with examples as disclosed herein. In some examples, aspects of the operations of 1515 may be performed by an energy threshold detector 730 as described with reference to FIG. 7.

At 1520, the method may include receiving the energy signaling via the set of conditional energy resources based on the one or more energy threshold conditions being satisfied at the first wireless device. The operations of 1520 may be performed in accordance with examples as disclosed herein. In some examples, aspects of the operations of 1520 may be performed by an energy signaling component 735 as described with reference to FIG. 7.

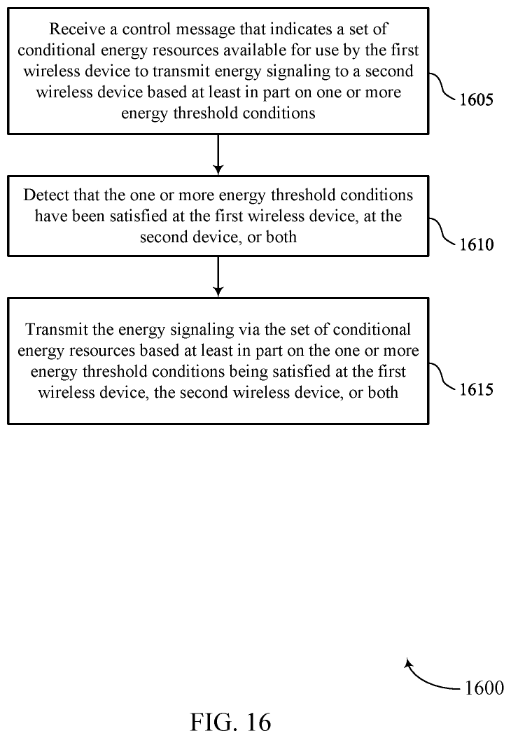

FIG. 16 shows a flowchart illustrating a method 1600 that supports exceptional resources for energy harvesting devices in accordance with one or more aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include receiving a control message that indicates a set of conditional energy resources available for use by the first wireless device to transmit energy signaling to a second wireless device based on one or more energy threshold conditions. The operations of 1605 may be performed in accordance with examples as disclosed herein. In some examples, aspects of the operations of 1605 may be performed by a control message management component 725 as described with reference to FIG. 7.

At 1610, the method may include detecting that the one or more energy threshold conditions have been satisfied at the first wireless device, at the second device, or both. The operations of 1610 may be performed in accordance with examples as disclosed herein. In some examples, aspects of the operations of 1610 may be performed by an energy threshold detector 730 as described with reference to FIG. 7.

At 1615, the method may include transmitting the energy signaling via the set of conditional energy resources based on the one or more energy threshold conditions being satisfied at the first wireless device, the second wireless device, or both. The operations of 1615 may be performed in accordance with examples as disclosed herein. In some examples, aspects of the operations of 1615 may be performed by a power consumption estimation component 745 as described with reference to FIG. 7.

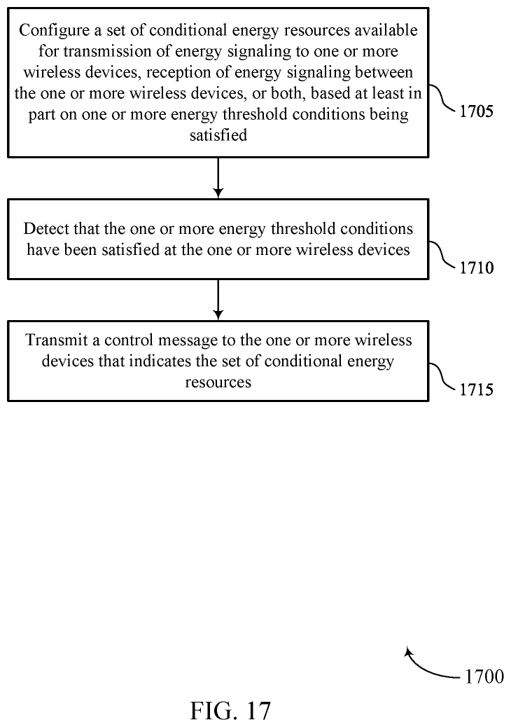

FIG. 17 shows a flowchart illustrating a method 1700 that supports exceptional resources for energy harvesting devices in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include configuring a set of conditional energy resources available for transmission of energy signaling to one or more wireless devices, reception of energy signaling between the one or more wireless devices, or both, based on one or more energy threshold conditions being satisfied. The operations of 1705 may be performed in accordance with examples as disclosed herein. In some examples, aspects of the operations of 1705 may be performed by an energy resource configuration component 1125 as described with reference to FIG. 11.

At 1710, the method may include detecting that the one or more energy threshold conditions have been satisfied at the one or more wireless devices. The operations of 1710 may be performed in accordance with examples as disclosed herein. In some examples, aspects of the operations of 1710 may be performed by an energy threshold condition detection component 1130 as described with reference to FIG. 11.

At 1715, the method may include transmitting a control message to the one or more wireless devices that indicates the set of conditional energy resources. The operations of 1715 may be performed in accordance with examples as disclosed herein. In some examples, aspects of the operations of 1715 may be performed by a control message transmitter 1135 as described with reference to FIG. 11.

The following provides an overview of aspects of the present disclosure:

Aspect 1: A method for wireless communications at a first wireless device, comprising: receiving a control message that indicates a set of conditional energy resources available for use by the first wireless device to receive energy signaling from a second wireless device based at least in part on one or more energy threshold conditions; detecting that the one or more energy threshold conditions have been satisfied at the first wireless device; and receiving the energy signaling via the set of conditional energy resources based at least in part on the one or more energy threshold conditions being satisfied at the first wireless device.

Aspect 2: The method of aspect 1, wherein the set of conditional energy resources comprises a set of one or more resource pools available for use by the first wireless device, the method further comprising: receiving, from the second wireless device, the energy signaling via the set of one or more resource pools, wherein a selection of the set of one or more resource pools is based at least in part on the one or more energy threshold conditions being satisfied.

Aspect 3: The method of any of aspects 1 through 2, wherein the set of conditional energy resources comprises a set of one or more sub-bands available for use by the first wireless device, the method further comprising: receiving, from the second wireless device, the energy signaling via the set of one or more sub-bands, wherein a selection of the set of one or more sub-bands is based at least in part on the one or more energy threshold conditions being satisfied.

Aspect 4: The method of any of aspects 1 through 3, wherein the one or more energy threshold conditions comprise an energy threshold associated with a communication link between the first wireless device and a network entity, the method further comprising: receiving the energy signaling via the set of conditional energy resources based at least in part on one or more of: an energy level associated with the communication link being lower than the energy threshold, a radio link failure on the communication link, or both.

Aspect 5: The method of any of aspects 1 through 4, wherein the one or more energy threshold conditions comprise a battery level threshold at the first wireless device, the method further comprising: receiving the energy signaling via the set of conditional energy resources based at least in part on a battery level of the first wireless device being lower than the battery level threshold.

Aspect 6: The method of any of aspects 1 through 5, wherein the one or more energy threshold conditions comprise a charging rate threshold at the first wireless device, the method further comprising: receiving the energy signaling via the set of conditional energy resources based at least in part on a charging rate of the first wireless device being lower than the charging rate threshold.

Aspect 7: The method of any of aspects 1 through 6, wherein the one or more energy threshold conditions comprise a threshold quantity of energy providing wireless devices associated with a second set of energy resources, the method further comprising: receiving the energy signaling via the set of conditional energy resources based at least in part on a quantity of energy providing wireless devices associated with the second set of energy resources being below the threshold quantity of energy providing wireless devices.

Aspect 8: The method of any of aspects 1 through 7, wherein the one or more energy threshold conditions comprise a threshold quantity of energy providing wireless devices associated with the set of conditional energy resources, the method further comprising: receiving the energy signaling via the set of conditional energy resources based at least in part on a quantity of energy providing wireless devices associated with the set of conditional energy resources exceeding the threshold quantity of energy providing wireless devices.

Aspect 9: The method of any of aspects 1 through 8, wherein the one or more energy threshold conditions comprise a threshold corresponding to a reduction in energy of the first wireless device over a time duration, the method further comprising: receiving the energy signaling via the set of conditional energy resources based at least in part on the reduction in the energy of the first wireless device over the time duration exceeding the threshold.

Aspect 10: The method of any of aspects 1 through 9, wherein the one or more energy threshold conditions comprise a threshold decrease in a predicted energy state of the first wireless device over a time duration, the method further comprising: receiving the energy signaling via the set of conditional energy resources based at least in part on the predicted energy state of the first wireless device decreasing an amount greater than the threshold decrease.

Aspect 11: The method of any of aspects 1 through 10, wherein the one or more energy threshold conditions comprise a threshold charging rate of the first wireless device over a time duration, the method further comprising: estimating a future charging rate of the first wireless device based at least in part on a current charging rate of the first wireless device; and receiving the energy signaling via the set of conditional energy resources based at least in part on the estimated future charging rate of the first wireless device being less than the threshold charging rate.

Aspect 12: The method of any of aspects 1 through 11, wherein the one or more energy threshold conditions comprise a threshold power consumption rate of the first wireless device over a time duration, the method further comprising: estimating a future power consumption rate of the first wireless device based at least in part on a current power consumption rate of the first wireless device; and receiving the energy signaling via the set of conditional energy resources based at least in part on the estimated future power consumption rate of the first wireless device being less than the threshold power consumption rate.

Aspect 13: The method of any of aspects 1 through 12, further comprising: receiving an indication of a ranking for one or more conditional energy resources of the set of conditional energy resources available for use by the first wireless device; and receiving the energy signaling via at least one conditional energy resource of the one or more conditional energy resources based at least in part on the ranking, wherein the ranking indicates an availability of the one or more conditional energy resources.

Aspect 14: The method of any of aspects 1 through 13, wherein the one or more energy threshold conditions comprise a battery level threshold of the first wireless device, a charging rate threshold of the first wireless device, a power consumption threshold of the first wireless device, or any combination thereof, the method further comprising: receiving a message requesting transmission of one or more high priority data messages from the first wireless device to the second wireless device; receiving the energy signaling via the set of conditional energy resources based at least in part on a battery level of the first wireless device being lower than the battery level threshold, a charging rate of the first wireless device being lower than the charging rate threshold, a power consumption of the first wireless device being greater than the power consumption threshold, or any combination thereof; and transmitting the one or more high priority data messages to the second wireless device based at least in part on the received energy signaling.

Aspect 15: The method of any of aspects 1 through 14, further comprising: receiving an instruction message that instructs the first wireless device to use the set of conditional energy resources.

Aspect 16: The method of any of aspects 1 through 15, further comprising: receiving the energy signaling via a first resource of the set of conditional energy resources based at least in part on a first threshold of the one or more energy threshold conditions being satisfied; or receiving the energy signaling via a second resource of the set of conditional energy resources based at least in part on a second threshold of the one or more energy threshold conditions being satisfied.

Aspect 17: The method of any of aspects 1 through 16, wherein the control message comprises a MIB, a SIB, a RRC message, an assistance information message, a layer indication message, or any combination thereof.

Aspect 18: The method of any of aspects 1 through 17, wherein the control message comprises a unicast configuration message, a broadcast configuration message, a multicast configuration message, or any combination thereof.

Aspect 19: The method of any of aspects 1 through 18, wherein the set of conditional energy resources available for use by the first wireless device to receive the energy signaling from the second wireless device is different from a second set of one or more resources available for use by the first wireless device to receive data messaging, control messaging, or both, from the second wireless device.

Aspect 20: A method for wireless communications at a first wireless device, comprising: receiving a control message that indicates a set of conditional energy resources available for use by the first wireless device to transmit energy signaling to a second wireless device based at least in part on one or more energy threshold conditions; detecting that the one or more energy threshold conditions have been satisfied at the first wireless device, at the second device, or both; and transmitting the energy signaling via the set of conditional energy resources based at least in part on the one or more energy threshold conditions being satisfied at the first wireless device, the second wireless device, or both.

Aspect 21: The method of aspect 20, wherein the set of conditional energy resources comprises a set of one or more sub-bands available for use by the first wireless device, one or more resource pools available for use by the first wireless device, or both, the method further comprising: transmitting, to the second wireless device, the energy signaling via the set of one or more sub-bands, the one or more resource pools, or both, based at least in part on the one or more energy threshold conditions being satisfied.

Aspect 22: The method of any of aspects 20 through 21, wherein the one or more energy threshold conditions comprise an energy threshold associated with a communication link between the second wireless device and a network entity, the method further comprising: transmitting the energy signaling via the set of conditional energy resources based at least in part on one or more of: an energy level associated with the communication link being lower than the energy threshold, a radio link failure on the communication link, or both.

Aspect 23: The method of any of aspects 20 through 22, wherein the one or more energy threshold conditions comprise a battery level threshold at the second wireless device, a charging rate threshold at the second wireless device, or both, the method further comprising: receiving an indication that a battery level of the second wireless device is lower than the battery level threshold, a charging rate of the second wireless device is lower than the charging rate threshold, or both; and transmitting the energy signaling via the set of conditional energy resources based at least in part on the indication that the battery level of the second wireless device is lower than the battery level threshold, the charging rate of the second wireless device is lower than the charging rate threshold, or both.

Aspect 24: The method of any of aspects 20 through 23, wherein the one or more energy threshold conditions comprise a threshold quantity of energy providing wireless devices associated with a second set of energy resources, the method further comprising: transmitting the energy signaling via the set of conditional energy resources based at least in part on a quantity of energy providing wireless devices associated with the second set of energy resources being below the threshold quantity of energy providing wireless devices.

Aspect 25: The method of any of aspects 20 through 24, wherein the one or more energy threshold conditions comprise a threshold quantity of energy providing wireless devices associated with the set of conditional energy resources, the method further comprising: transmitting the energy signaling via the set of conditional energy resources based at least in part on a quantity of energy providing wireless devices associated with the set of conditional energy resources exceeding the threshold quantity of energy providing wireless devices.

Aspect 26: The method of any of aspects 20 through 25, wherein the one or more energy threshold conditions comprise a threshold corresponding to a reduction in energy of the second wireless device over a time duration, the method further comprising: receiving an indication that the reduction in energy of the second wireless device over the time duration exceeds the threshold; and transmitting the energy signaling via the set of conditional energy resources based at least in part on the reduction in the energy of the second wireless device over the time duration exceeding the threshold.

Aspect 27: The method of any of aspects 20 through 26, wherein the one or more energy threshold conditions comprise a battery level threshold of the second wireless device, a charging rate threshold of the second wireless device, a power consumption threshold of the first wireless device, or any combination thereof, the method further comprising: receiving a message indicating that the second wireless device has one or more high priority data messages to transmit; and transmitting the energy signaling via the set of conditional energy resources based at least in part on a battery level of the second wireless device being lower than the battery level threshold, a charging rate of the second wireless device being lower than the charging rate threshold, a power consumption of the first wireless device being greater than the power consumption threshold, or any combination thereof.

Aspect 28: The method of any of aspects 20 through 27, further comprising: transmitting the energy signaling via a first resource of the set of conditional energy resources based at least in part on a first threshold of the one or more energy threshold conditions being satisfied; or transmitting the energy signaling via a second resource of the set of conditional energy resources based at least in part on the one or more energy threshold conditions being satisfied.

Aspect 29: A method for wireless communications at a network entity, comprising: configuring a set of conditional energy resources available for transmission of energy signaling to one or more wireless devices, reception of energy signaling between the one or more wireless devices, or both, based at least in part on one or more energy threshold conditions being satisfied; detecting that the one or more energy threshold conditions have been satisfied at the one or more wireless devices; and transmitting a control message to the one or more wireless devices that indicates the set of conditional energy resources.

Aspect 30: An apparatus for wireless communications at a first wireless device, comprising at least one processor, and memory coupled with the at least one processor, the memory storing instructions executable by the at least one processor to cause the first wireless device to perform a method of any of aspects 1 through 19.

Aspect 31: An apparatus for wireless communications at a first wireless device, comprising at least one means for performing a method of any of aspects 1 through 19.

Aspect 32: A non-transitory computer-readable medium storing code for wireless communications at a first wireless device, the code comprising instructions executable by at least one processor to perform a method of any of aspects 1 through 19.

Aspect 33: An apparatus for wireless communications at a first wireless device, comprising at least one processor, and memory coupled with the at least one processor, the memory storing instructions executable by the at least one processor to cause the first wireless device to perform a method of any of aspects 20 through 28.

Aspect 34: An apparatus for wireless communications at a first wireless device, comprising at least one means for performing a method of any of aspects 20 through 28.

Aspect 35: A non-transitory computer-readable medium storing code for wireless communications at a first wireless device, the code comprising instructions executable by at least one processor to perform a method of any of aspects 20 through 28.

Aspect 36: An apparatus for wireless communications at a network entity, comprising at least one processor, and memory coupled with the at least one processor, the memory storing instructions executable by the at least one processor to cause the network entity to perform a method of any of aspects 29 through 29.

Aspect 37: An apparatus for wireless communications at a network entity, comprising at least one means for performing a method of any of aspects 29 through 29.

Aspect 38: A non-transitory computer-readable medium storing code for wireless communications at a network entity, the code comprising instructions executable by at least one processor to perform a method of any of aspects 29 through 29.

It should be noted that the methods described herein describe possible implementations, and that the operations and the steps may be rearranged or otherwise modified and that other implementations are possible. Further, aspects from two or more of the methods may be combined.

A wireless network, for example a wireless local area network (WLAN), such as a Wi-Fi (e.g., Institute of Electrical and Electronics Engineers (IEEE)802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communications system may be coupled (for example, operatively, communicatively, functionally, electronically, and/or electrically) to each other.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. At least one processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by at least one processor, or both. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by at least one processor, the functions may be stored as or transmitted using one or more instructions or code of a computer-readable medium. Other examples and implementations are within the scope of the disclosure and appended claims. For example, due to the nature of software, functions described herein may be implemented using software executed by at least one processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first wireless device, comprising:
at least one processor; and
memory coupled with the at least one processor, the memory storing instructions executable by the at least one processor to cause the first wireless device to:
receive a control message that indicates a set of conditional energy resources available for use by the first wireless device to receive energy signaling from a second wireless device based at least in part on one or more energy threshold conditions;
detect that the one or more energy threshold conditions have been satisfied at the first wireless device; and
receive the energy signaling via the set of conditional energy resources based at least in part on the one or more energy threshold conditions being satisfied at the first wireless device.

2. The apparatus of claim 1, wherein the set of conditional energy resources comprises a set of one or more resource pools available for use by the first wireless device, and the instructions are further executable by the at least one processor to cause the first wireless device to:
receive, from the second wireless device, the energy signaling via the set of one or more resource pools, wherein a selection of the set of one or more resource pools is based at least in part on the one or more energy threshold conditions being satisfied.

3. The apparatus of claim 1, wherein the set of conditional energy resources comprises a set of one or more sub-bands available for use by the first wireless device, and the instructions are further executable by the at least one processor to cause the first wireless device to:
receive, from the second wireless device, the energy signaling via the set of one or more sub-bands, wherein a selection of the set of one or more sub-bands is based at least in part on the one or more energy threshold conditions being satisfied.

4. The apparatus of claim 1, wherein the one or more energy threshold conditions comprise an energy threshold associated with a communication link between the first wireless device and a network entity, and the instructions are further executable by the at least one processor to cause the first wireless device to:
receive the energy signaling via the set of conditional energy resources based at least in part on one or more of: an energy level associated with the communication link being lower than the energy threshold, a radio link failure on the communication link, or both.

5. The apparatus of claim 1, wherein the one or more energy threshold conditions comprise a battery level threshold at the first wireless device, and the instructions are further executable by the at least one processor to cause the first wireless device to:
receive the energy signaling via the set of conditional energy resources based at least in part on a battery level of the first wireless device being lower than the battery level threshold.

6. The apparatus of claim 1, wherein the one or more energy threshold conditions comprise a charging rate threshold at the first wireless device, and the instructions are further executable by the at least one processor to cause the first wireless device to:
receive the energy signaling via the set of conditional energy resources based at least in part on a charging rate of the first wireless device being lower than the charging rate threshold.

7. The apparatus of claim 1, wherein the one or more energy threshold conditions comprise a threshold quantity of energy providing wireless devices associated with a second set of energy resources, and the instructions are further executable by the at least one processor to cause the first wireless device to:
receive the energy signaling via the set of conditional energy resources based at least in part on a quantity of energy providing wireless devices associated with the second set of energy resources being below the threshold quantity of energy providing wireless devices.

8. The apparatus of claim 1, wherein the one or more energy threshold conditions comprise a threshold quantity of energy providing wireless devices associated with the set of conditional energy resources, and the instructions are further executable by the at least one processor to cause the first wireless device to:
receive the energy signaling via the set of conditional energy resources based at least in part on a quantity of energy providing wireless devices associated with the set of conditional energy resources exceeding the threshold quantity of energy providing wireless devices.

9. The apparatus of claim 1, wherein the one or more energy threshold conditions comprise a threshold corresponding to a reduction in energy of the first wireless device over a time duration, and the instructions are further executable by the at least one processor to cause the first wireless device to:
receive the energy signaling via the set of conditional energy resources based at least in part on the reduction in the energy of the first wireless device over the time duration exceeding the threshold.

10. The apparatus of claim 1, wherein the one or more energy threshold conditions comprise a threshold decrease in a predicted energy state of the first wireless device over a time duration, and the instructions are further executable by the at least one processor to cause the first wireless device to:
receive the energy signaling via the set of conditional energy resources based at least in part on the predicted energy state of the first wireless device decreasing an amount greater than the threshold decrease.

11. The apparatus of claim 1, wherein the one or more energy threshold conditions comprise a threshold charging rate of the first wireless device over a time duration, and the instructions are further executable by the at least one processor to cause the first wireless device to:
estimate a future charging rate of the first wireless device based at least in part on a current charging rate of the first wireless device; and
receive the energy signaling via the set of conditional energy resources based at least in part on the estimated future charging rate of the first wireless device being less than the threshold charging rate.

12. The apparatus of claim 1, wherein the one or more energy threshold conditions comprise a threshold power consumption rate of the first wireless device over a time duration, and the instructions are further executable by the at least one processor to cause the first wireless device to:
estimate a future power consumption rate of the first wireless device based at least in part on a current power consumption rate of the first wireless device; and
receive the energy signaling via the set of conditional energy resources based at least in part on the estimated future power consumption rate of the first wireless device being less than the threshold power consumption rate.

13. The apparatus of claim 1, wherein the instructions are further executable by the at least one processor to cause the first wireless device to:
receive an indication of a ranking for one or more conditional energy resources of the set of conditional energy resources available for use by the first wireless device; and
receive the energy signaling via at least one conditional energy resource of the one or more conditional energy resources based at least in part on the ranking, wherein the ranking indicates an availability of the one or more conditional energy resources.

14. The apparatus of claim 1, wherein the one or more energy threshold conditions comprise a battery level threshold of the first wireless device, a charging rate threshold, a power consumption threshold, or a combination thereof, and the instructions are further executable by the at least one processor to cause the first wireless device to:
receive a message requesting transmission of one or more high priority data messages from the first wireless device to the second wireless device;
receive the energy signaling via the set of conditional energy resources based at least in part on a battery level of the first wireless device being lower than the battery level threshold, a charging rate of the first wireless device being lower than the charging rate threshold, a power consumption of the first wireless device being greater than the power consumption threshold, or any combination thereof; and
transmit the one or more high priority data messages to the second wireless device based at least in part on the received energy signaling.

15. The apparatus of claim 1, wherein the instructions are further executable by the at least one processor to cause the first wireless device to:
receive an instruction message that instructs the first wireless device to use the set of conditional energy resources.

16. The apparatus of claim 1, wherein the instructions are further executable by the at least one processor to cause the first wireless device to:
receive the energy signaling via a first resource of the set of conditional energy resources based at least in part on a first threshold of the one or more energy threshold conditions being satisfied; or
receive the energy signaling via a second resource of the set of conditional energy resources based at least in part on a second threshold of the one or more energy threshold conditions being satisfied.

17. (canceled)

18. (canceled)

19. The apparatus of claim 1, wherein the set of conditional energy resources available for use by the first wireless device to receive the energy signaling from the second wireless device is different from a second set of one or more resources available for use by the first wireless device to receive data messaging, control messaging, or both, from the second wireless device.

20. An apparatus for wireless communications at a first wireless device, comprising:
at least one processor; and
memory coupled with the at least one processor, the memory storing instructions executable by the at least one processor to cause the first wireless device to:
receive a control message that indicates a set of conditional energy resources available for use by the first wireless device to transmit energy signaling to a second wireless device based at least in part on one or more energy threshold conditions;
detect that the one or more energy threshold conditions have been satisfied at the first wireless device, at the second wireless device, or both; and transmit the energy signaling via the set of conditional energy resources based at least in part on the one or more energy threshold conditions being satisfied at the first wireless device, the second wireless device, or both.

21. The apparatus of claim 20, wherein the set of conditional energy resources comprises a set of one or more sub-bands available for use by the first wireless device, one or more resource pools, or both, and the instructions are further executable by the at least one processor to cause the first wireless device to:
transmit, to the second wireless device, the energy signaling via the set of one or more sub-bands, the one or more resource pools, or both, based at least in part on the one or more energy threshold conditions being satisfied.

22. -28. (canceled)

29. An apparatus for wireless communications at a network entity, comprising:
at least one processor; and
memory coupled with the at least one processor, the memory storing instructions executable by the at least one processor to cause the network entity to:
configure a set of conditional energy resources available for transmission of energy signaling to one or more wireless devices, reception of energy signaling between the one or more wireless devices, or both, based at least in part on one or more energy threshold conditions being satisfied;
detect that the one or more energy threshold conditions have been satisfied at the one or more wireless devices; and
transmit a control message to the one or more wireless devices that indicates the set of conditional energy resources.

30. (canceled)
